(19) United States
(12) Patent Application Publication
(10) Pub. No.: US 2026/0048382 A1
(43) Pub. Date: Feb. 19, 2026

(54) HYPER-CROSS-LINKED POLYAMIDE/POLYAMINE 3D-NETWORK FOR WATER TREATMENT

(71) Applicant: KING FAHD UNIVERSITY OF PETROLEUM AND MINERALS, Dhahran (SA)

(72) Inventors: Abdul WAHEED, Dhahran (SA); Muhammad SAJID, Dhahran (SA); Mohammad ASIF, Dhahran (SA)

(73) Assignee: KING FAHD UNIVERSITY OF PETROLEUM AND MINERALS, Dhahran (SA)

(21) Appl. No.: 19/089,524

(22) Filed: Mar. 25, 2025

Related U.S. Application Data
(60) Provisional application No. 63/683,143, filed on Aug. 14, 2024.

(51) Int. Cl. B01J 20/26; B01J 20/28; B01J 20/30; B01J 20/34; C02F 1/28; C02F 101/22; C02F 101/30; C08G 69/36

(52) U.S. Cl. CPC B01J 20/267; B01J 20/28004; B01J 20/28007; B01J 20/28011; B01J 20/28016; B01J 20/28059; B01J 20/28071; B01J 20/2808; B01J 20/28083; B01J 20/3085; B01J 20/3425; B01J 20/3475; C02F 1/285; C08G 69/36; C02F 2101/22; C02F 2101/308; C02F 2303/16

(57) ABSTRACT

A polymeric adsorbent including a polymer having reacted units of a tetraethylenepentamine (TEPA), reacted units of a 3,5-diacrylamidobenzoic acid, and reacted units of a methacrylamide. The TEPA, the 3,5-diacrylamidobenzoic acid, and the methacrylamide have a molar ratio of 2 to 4:1 to 3:0.5 to 2. Reacted units of the TEPA and reacted units of the 3,5-diacrylamidobenzoic acid are covalently crosslinked, and reacted units of the TEPA and reacted units of the methacrylamide are covalently crosslinked. The polymeric adsorbent of the present disclosure can be used for water treatment.

### CROSS REFERENCE TO RELATED APPLICATION

This application claims the benefit of U.S. Provisional Application No. 63/683,143, filed Aug. 14, 2024, which is incorporated herein by reference in its entirety.

### STATEMENT REGARDING PRIOR DISCLOSURE BY THE INVENTORS

Aspects of the present disclosure are described in Waheed, A., Sajid, M., and Asif, A., “Green synthesis of a mesoporous hyper-cross-linked polyamide/polyamine 3D network through Michael addition for the treatment of heavy metals and organic dyes contaminated wastewater” published in Volume 340, Chemosphere, which is incorporated herein by reference in its entirety.

### STATEMENT OF ACKNOWLEDGEMENT

Support provided by the Interdisciplinary Research Center for Membranes and Water Security, King Fahd University of Petroleum and Minerals, Saudi Arabia, through Project INMW2306 and Applied Research Center for Environment and Marine Studies, Research Institute, King Fahd University of Petroleum and Minerals, Saudi Arabia is gratefully acknowledged.

### BACKGROUND

### Technical Field

The present disclosure is directed to adsorbents, and particularly to a hyper-cross-linked polyamide/polyamine three-dimensional (3D) network (TABAMA resin) for water treatment.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present disclosure.

Environmental pollution has become a challenge in the modern era due to rapid industrialization and urbanization in the last century. The contamination of aquatic and terrestrial ecosystems has reached alarming levels, resulting from a wide array of pollutants, including organic compounds, heavy metals, radioactive elements, toxic gases, nanoparticles, and the like. Heavy metals and organic dyes are inherently toxic and have adverse effects on living organisms.

Water treatment technologies applied to remove metallic and organic contaminants from water and wastewater vary depending on the nature of the pollutants and their levels in the water. Chemical precipitation, ion exchange, membrane filtration, biological treatment, advanced oxidation process, electrochemical treatment, coagulation, and adsorption are among some commonly employed technologies for the removal of metals and organic dyes from water.

Adsorption has been used as a water treatment technique because of its versatility in selecting the adsorbents, efficiency in the high removal rates, cost-effectiveness, selectivity, ease of operation, environmental friendliness, and easy regeneration. The selection or synthesis of the adsorbent is a determination parameter in adsorption-based water treatment. An efficient adsorbent should demonstrate high adsorption capacity, fast adsorption kinetics, selectivity, chemical stability under operating conditions of water treatment, high surface area, environmental compatibility, renewability, resistance to fouling, and easy large-scale production. Large-scale production promotes the applicability of adsorbents in real-world applications, such as the treatment of industrial and/or municipal wastewater. No single adsorbent may possess every favorable characteristics; therefore, efforts are made to tailor the properties of the adsorbents as they pertain to varying water treatment applications.

A range of adsorbents, including activated carbon, carbon nanotubes, graphene, graphene derivatives, zeolites, metal-organic frameworks, microgels, layered double hydroxides, agricultural-derived materials, and hyper-cross-linked polymers (HCPs), have been used for remediation of heavy metals and organic dyes from wastewater. Adsorbents have advantages and limitations. A majority of synthetic adsorbents involve tedious procedures and harsh reaction conditions during their synthesis, and few of them are selective towards the target pollutants. HCPs show beneficial properties such as high surface areas, porous and robust structures, chemical and mechanical stability, ease of scale-up, reasonable thermal stability, low cost, and good adsorption capacities. These simple reaction-based strategies may provide a way of scalable production of adsorbents for real-world applications.

Although several HCPs adsorbents have been developed in the past for water treatment, more competent materials for pollutant removal with enhanced efficiency and selectivity still need to be fabricated and explored. Accordingly, an objective of the present disclosure is to describe a hyper-cross-linked polyamide/polyamine three-dimensional network for water treatment that overcomes drawbacks of the art.

### SUMMARY

In an exemplary embodiment, a polymeric adsorbent is described. The polymeric adsorbent includes a polymer having reacted units of a tetraethylenepentamine (TEPA), reacted units of a 3,5-diacrylamidobenzoic acid, and reacted units of a methacrylamide. The TEPA, the 3,5-diacrylamidobenzoic acid, and the methacrylamide have a molar ratio of 2 to 4:1 to 3:0.5 to 2. The polymer is covalently crosslinked through at least a portion of the reacted units of the TEPA and the reacted units of the 3,5-diacrylamidobenzoic acid. The polymer is covalently crosslinked through at least a portion of the reacted units of the TEPA and the reacted units of the methacrylamide.

In some embodiments, one or more primary amines and one or more secondary amines of the reacted units of the TEPA are covalently bonded to the reacted units of the 3,5-diacrylamidobenzoic acid through one or more primary carbons of the reacted units of the 3,5-diacrylamidobenzoic acid.

In some embodiments, one or more primary amines and one or more secondary amines of the reacted units of the TEPA are covalently bonded to the reacted units of the methacrylamide through one or more primary carbons of the reacted units of the methacrylamide.

In another exemplary embodiment, a method of making the polymer is described. The method includes dissolving the 3,5-diacrylamidobenzoic acid and the methacrylamide in a polar organic solvent to form a first solution and mixing the TEPA with the first solution at a temperature of −10 to 10 degrees Celsius (° C.) for 30 to 90 minutes (min) to form a second mixture. The method further includes mixing the second mixture at a temperature of 40 to 60° C. and refluxing the second mixture to form the polymer.

In some embodiments, the adsorbent is in the form of agglomerates having a longest dimension of 5 to 50 μm made of particles having an average particle size of 25 to 250 nm and a surface area of 5 to 15 meter square per gram (m²/g).

In some embodiments, the adsorbent is in the form of particles that are porous and have a pore volume of 0.01 to 0.1 cubic centimeters per gram (cm³/g).

In some embodiments, the adsorbent is in the form of particles that are porous and have a pore size of 1 to 3 nanometers (nm).

In some embodiments, the adsorbent is in the form of particles that are agglomerated and have an average particle size of 50 to 300 nm.

In yet another exemplary embodiment, a method of water treatment is described. The method includes contacting the polymeric adsorbent with an aqueous solution, including one or more pollutants, adsorbing one or more pollutants on the polymeric adsorbent, and collecting a filtrate solution. The filtrated solution has fewer pollutants than the aqueous solution.

In some embodiments, the one or more pollutants are one or more metal ions and the one or more metal ions are adsorbed onto the polymeric adsorbent through metal-ligand complexation with one or more amines of the reacted units of the TEPA and the reacted units of the methacrylamide.

In some embodiments, the one or more pollutants are one or more metal ions and the one or more metal ions are adsorbed onto the polymeric adsorbent through electrostatic interactions with one or more oxygen-containing functional groups of the reacted units of the 3,5-diacrylamidobenzoic acid and the reacted units of the methacrylamide.

In some embodiments, the method further includes washing and drying the polymeric adsorbent after contacting the polymeric adsorbent with the aqueous solution to regenerate the polymeric adsorbent. The method further includes contacting the regenerated polymeric adsorbent with an aqueous solution including one or more pollutants, and adsorbing the one or more pollutants on the regenerated polymeric adsorbent.

In some embodiments, the regenerated polymeric adsorbent has a removal efficiency of one or more pollutants of at least 50 percent (%) based on an initial amount of one or more pollutants in the aqueous solution.

In some embodiments, the adsorption of one or more pollutants occurs in less than 10 minutes.

In some embodiments, the adsorbent has an adsorption capacity of 58 to 64 milligrams per gram (mg/g) for cadmium ions.

In some embodiments, the adsorbent has an adsorption capacity of 116 to 122 mg/g for chromium ions.

In some embodiments, the adsorbent has an adsorption capacity of 5 to 15 mg/g for lead ions.

In some embodiments, the adsorbent has a dye removal efficiency for Eriochrome black T (EBT) of at least 99% based on an initial amount of the EBT.

In some embodiments, the adsorbent has a dye removal efficiency for methyl orange (MO) of 35% to 45% based on an initial amount of the MO.

In some embodiments, carboxylic acid functional groups in the reacted units of the 3,5-diacrylamidobenzoic acid do not react with reacted units of the TEPA and reacted units of the TEPA.

These and other aspects of the non-limiting embodiments of the present disclosure will become apparent to those skilled in the art upon review of the following description of specific non-limiting embodiments of the disclosure in conjunction with the accompanying drawings. The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure (including alternatives and/or variations thereof) and many of the attendant advantages thereof will be readily obtained as the same becomes better understood by reference to the following detailed description when considered in connection with the accompanying drawings, wherein:

FIG. 1A is a flowchart depicting a method for making a polymer (TABAMA resin), according to certain embodiments.

FIG. 1B is a flowchart depicting a method for water treatment using the polymer as an adsorbent, according to certain embodiments.

FIG. 1C is a schematic illustration depicting reaction conditions for a Michael addition and the structure of TABAMA resin, according to certain embodiments.

FIG. 2A shows a Fourier-transform infrared (FTIR) spectrum of the polymer, according to certain embodiments.

FIG. 2B shows a powder X-ray diffraction (PXRD) pattern of the polymer, according to certain embodiments.

FIG. 2C shows a plot for thermogravimetric analysis (TGA) analysis of the polymer, according to certain embodiments.

FIG. 2D depicts a nitrogen (N₂) adsorption-desorption isotherm of the polymer, according to certain embodiments.

FIG. 3A is a scanning electron microscopy (SEM) image of the polymer at a 10 micrometer (μm) scale, according to certain embodiments.

FIG. 3B is a high-resolution transmission electron microscopy (HR-TEM) image of the polymer at a 500 nanometer (nm) scale, according to certain embodiments.

FIG. 3C is an SEM image of the polymer at a 5 μm scale, according to certain embodiments.

FIG. 3D is an HR-TEM image of the polymer at a 50 nm scale, according to certain embodiments.

FIG. 3E is an SEM image of the polymer at a 1 μm scale, according to certain embodiments.

FIG. 3F is an HR-TEM image of the polymer at a 10 nm scale, according to certain embodiments.

FIG. 4A shows a structure of the polymer and its interactions with heavy metal ions, according to certain embodiments.

FIG. 4B shows FTIR spectra of unloaded polymer (TABAMA resin) and metal-loaded polymer, according to certain embodiments.

FIG. 4C shows elemental mapping analysis of unloaded polymer showing the presence of carbon (C), oxygen (O), and nitrogen (N), according to certain embodiments.

FIG. 4D shows elemental mapping analysis of metal-loaded polymer, showing the presence of C, O, N, cadmium (Cd), chromium (Cr), and lead (Pb), according to certain embodiments.

FIG. 5A shows an energy-dispersive X-ray spectroscopy (EDX) spectrum of unloaded polymer, according to certain embodiments.

FIG. 5B is an EDX spectrum of metal-loaded polymer, according to certain embodiments.

FIG. 6A is an SEM image of unloaded polymer at a 1 μm scale, according to certain embodiments.

FIG. 6B is an HR-TEM image of unloaded polymer at a 500 nm scale, according to certain embodiments.

FIG. 6C is an SEM image of metal-loaded polymer at a 10 μm scale, according to certain embodiments.

FIG. 6D is an HR-TEM image of metal-loaded polymer at a 50 nm scale, according to certain embodiments.

FIG. 6E is an SEM image of metal-loaded polymer at a 5 μm scale, according to certain embodiments.

FIG. 6F is an HR-TEM image of metal-loaded polymer at a 5 nm scale, according to certain embodiments.

FIG. 6G is a selected area electron diffraction (SAED) pattern of unloaded polymer, according to certain embodiments.

FIG. 6H is an SAED pattern of metal-loaded polymer, according to certain embodiments.

FIG. 7A shows a plot for the removal percentage of metal ions as a function of pH by the polymer, according to certain embodiments.

FIG. 7B shows a mechanism of interaction of metal ions with TABAMA resin at acidic and basic pH, according to certain embodiments.

FIG. 7C shows a plot for the removal adsorbent dosage for removing metal ions, according to certain embodiments.

FIG. 7D is a plot showing the effect of increasing metal ions concentrations, according to certain embodiments.

FIG. 7E is a plot showing the effect of time on the adsorption capacity of the tested metal ions, according to certain embodiments.

FIG. 8A shows a Langmuir adsorption isotherm for removing cadmium (Cd), according to certain embodiments.

FIG. 8B shows a Langmuir adsorption isotherm for removing chromium (Cr), according to certain embodiments.

FIG. 8C shows a Langmuir adsorption isotherm for removing lead (Pb), according to certain embodiments.

FIG. 8D shows a Freundlich adsorption isotherm for removing Cd, according to certain embodiments.

FIG. 8E shows a Freundlich adsorption isotherm for removing Cr, according to certain embodiments.

FIG. 8F shows a Freundlich adsorption isotherm for removing Pb, according to certain embodiments.

FIG. 8G shows pseudo-first-order kinetics models for the removal of metal ions, according to certain embodiments.

FIG. 8H shows pseudo-second-order kinetics models for the removal of metal ions, according to certain embodiments.

FIG. 9 shows regeneration cycles of the polymer for adsorptive removal of Cd, Cr, and Pb, according to certain embodiments.

FIG. 10A shows the chemical structures of eriochrome black t (EBT) and methyl orange (MO) dyes, according to certain embodiments.

FIG. 10B shows experimental samples of EBT and MO dye solutions after 5 minutes (min) stirring with the polymer at pH=7, according to certain embodiments.

FIG. 10C shows absorption spectra of EBT by the polymer, according to certain embodiments.

FIG. 10D shows absorption spectra of MO by the polymer, according to certain embodiments.

FIG. 10E compares the absorption spectra of EBT and MO by the polymer, according to certain embodiments.

FIG. 10F shows the absorption spectra of EBT, MO, and EBT/MO mixture before and after adsorption by the polymer, according to certain embodiments.

### DETAILED DESCRIPTION

In the following description, it is understood that other embodiments may be utilized, and structural and operational changes may be made without departure from the scope of the present embodiments disclosed herein.

Reference will now be made to specific embodiments or features, examples of which are illustrated in the accompanying drawings. In the drawings, whenever possible, corresponding or similar reference numerals will be used to designate identical or corresponding parts throughout the several views. Moreover, references to various elements described herein are made collectively or individually when there may be more than one element of the same type. However, such references are merely exemplary in nature. It may be noted that any reference to elements in the singular may also be constructed to relate to the plural and vice-versa without limiting the scope of the disclosure to the exact number or type of such elements unless set forth explicitly in the appended claims.

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all embodiments of the disclosure are shown.

In the drawings, reference numerals designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

As used herein, the term “compound” refers to a chemical entity, regardless of its phase (solid, liquid, or gaseous), as well as its state: crude mixture, purified, or isolated.

As used herein, the term “particle size” may be thought of as the length or longest dimension of a particle. The greatest distance that can be measured from one point on a shape through its center to a point directly across from it is referred to as the “diameter” for a circle, oval, ellipse, and multilobe. Unless otherwise noted, the term “diameter” for polygonal shapes refers to the maximum length that can be measured between a polygon's vertex at the center of the face and its opposite vertex.

As used herein, the term “porosity” refers to a measure of the void or vacant spaces within a material.

As used herein, the term “pore size” may be considered the length or longest dimension of a pore opening and/or a volume of a pore opening.

As used herein the term “deionized water” refers to the water that has (most of) the ions removed.

As used herein, the term “room temperature” refers to a temperature range of 25 degrees Celsius (° C.)±3° C. in the present disclosure.

As used herein, “monomer(s)” refers to a molecule that can undergo polymerization, thereby contributing constitutional repeating units to the structures of a macromolecule or polymer.

As used herein, “polymerization” refers to the process by which monomers combine end to end to form a polymer.

As used herein, “copolymer” refers to a polymer derived from more than one species of monomer and obtained by “copolymerization” of more than one species of monomer. Copolymers obtained by copolymerization of two monomers and/or oligomer species, may be termed bipolymers, those obtained from three monomers may be termed terpolymers, and those obtained from four monomers may be termed quarter polymers, etc.

As used herein, “crosslinking,” “cross-linking,” “crosslinked,” “cross-linked,” a “crosslink,” or a “cross-link” refers to polymers and resins containing branches that connect polymer chains via bonds that link one polymer chain to another. The crosslink may be an atom, a group of atoms, and/or a number of branch points connected by bonds, groups of atoms, and/or polymer chains. A crosslink may be formed by chemical reactions that are initiated by heat, pressure, radiation, change in pH, and the like, with the presence of at least one crosslinking monomer having more than two extension points, which is a monomer having more than two reactive sites. The above terms also include “hypercrosslinked” or “hyper-cross-linked” polymers and resins, which exhibit two-dimensional (2D) polymer backbones or three-dimensional (3D) resin networks.

As used herein, the term “Michael addition” refers to C—C bond formation reactions in which nucleophilic addition of a carbanion or another nucleophile to an α,β-unsaturated carbonyl compound containing an electron-withdrawing group takes place.

As used herein, the term “pollutant” refers to a substance introduced into the environment (i.e., air, gas, water, liquid, and the like) that has undesired and/or detrimental consequences.

As used herein, the term “adsorbent” refers to materials, either natural or artificial, that have an amorphous and/or microcrystalline structure and pores on their surface that can aid in the separation process via adsorption.

As used herein, the term “adsorbate” refers to ions, atoms, or particles that adhere to the surface of an adsorbent.

As used herein, the term “adsorption” refers to the adhesion of atoms, ions, or molecules from a gas, liquid, or dissolved solid to a surface.

As used herein, the term “chemisorption” refers to a type of adsorption that involves a chemical reaction between the adsorbate and adsorbent. New chemical bonds are formed on the adsorbent surface.

As used herein, the term “physisorption” refers to a type of adsorption that leaves the chemical species of the adsorbate and adsorbent intact, and the electronic structure of the atom or molecule is not perturbed upon adsorption, unlike chemisorption. Physisorption interactions may include electrostatic interactions, such as hydrogen bonding, dipole-dipole interactions, van der Waals interactions, and the like.

As used herein, the term “adsorption capacity” refers to the amount of adsorbate taken up by the adsorbent per unit mass (or volume) of the adsorbent.

As used herein, the term “removal efficiency” refers to the percent of contaminant and/or pollutant adsorbed by adsorbent.

As used herein, “dyes” refers to a natural or man-made colored compound that may used in the textile industry, food industry, cosmetics, dye-sensitized solar cells, UV protective clothing, and the like.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

The present disclosure is intended to include all hydration states of a given compound or formula, unless otherwise noted or when heating a material.

In addition, the present disclosure is intended to include all isotopes of atoms occurring in the present compounds and complexes. Isotopes include those atoms having the same atomic number but different mass numbers.

Aspects of the present disclosure are directed to a polymer adsorbent, including a hyper-cross-linked polyamide/polyamine 3D network (TABAMA resin), synthesized through a single-step Michael addition reaction. The polymer adsorbent can be used for the adsorptive removal of organic dyes, heavy metals, and pollutants from aqueous media with enhanced efficiency and selectivity.

A polymeric adsorbent (TABAMA resin) is described. As used herein, the terms “polymer,” “TABAMA resin,” “TABAMA,” “resin,” “adsorbent,” and “polymeric adsorbent” are used interchangeably in the present disclosure. The polymeric adsorbent includes a polymer having reacted units of a tetraethylenepentamine (TEPA), reacted units of a 3,5-diacrylamidobenzoic acid, and reacted units of a methacrylamide. In some embodiments, the molar ratio of TEPA to 3,5-diacrylamidobenzoic acid ranges from 1:1 to 4:1, preferably 1.5:1 to 3.5:1, and preferably 2:1 to 3:1. In some embodiments, the molar ratio of 3,5-diacrylamidobenzoic acid to methacrylamide ranges from 1:0.5 to 3:2, and preferably 1:1 to 2.5:1.5. In some embodiments, the molar ratio of TEPA to methacrylamide ranges from 4:1 to 1:1, preferably 3.5:1 to 1.5:1, and preferably 3:1 to 2:1. In some embodiments, the molar ratio of TEPA to 3,5-diacrylamidobenzoic acid to methacrylamide ranges from 1:0.5:0.25 to 5:4:3, preferably 2:1:0.5 to 4:3:2, and preferably 2.5:1.5:1.0 to 3.5:2.5:1.5. In a preferred embodiment, the molar ratio of TEPA to 3,5-diacrylamidobenzoic acid to methacrylamide is 2:1:0.5 to 4:3:2.

The amine of the reacted units of TEPA is bonded to the reacted units of 3,5-diacrylamidobenzoic acid, more specifically to the one or more primary carbons of 3,5-diacrylamidobenzoic acid. The amine can be a primary amine, a secondary amine, or both. The nature of bonding between the reacted units of TEPA and the reacted units of 3,5-diacrylamidobenzoic acid is preferably a covalent bond. In a preferred embodiment, one or more primary amines and one or more secondary amines of the reacted units of the TEPA are covalently bonded to the reacted units of the 3,5-diacrylamidobenzoic acid through one or more primary carbons of the reacted units of the 3,5-diacrylamidobenzoic acid. In one embodiment, the reacted units of TEPA may be covalently bonded through a primary amine to a primary carbon of a reacted unit of the 3,5-diacrylamidobenzoic acid. In another embodiment, the reacted units of TEPA may be covalently bonded through a secondary amine to a primary carbon of a reacted unit of the 3,5-diacrylamidobenzoic acid. In some embodiments, the reacted units of TEPA may be bonded to one or more reacted units of TEPA through a primary amine, a secondary amine, or both. The amine of the reacted units of TEPA is bonded to the reacted units of methacrylamide, more specifically to the one or more primary carbons of methacrylamide. The amine can be a primary amine, a secondary amine, or both. The nature of bonding between the reacted units of TEPA and the reacted units of methacrylamide is preferably a covalent bond. In a preferred embodiment, one or more primary amines and one or more secondary amines of the reacted units of the TEPA are covalently bonded to the reacted units of the methacrylamide through one or more primary carbons of the reacted units of the methacrylamide. In one embodiment, the reacted units of TEPA may be covalently bonded through a primary amine to a primary carbon of a reacted unit of the methacrylamide. In another embodiment, the reacted units of TEPA may be covalently bonded through a secondary amine to a primary carbon of a reacted unit of the methylacrylamide. In some embodiments, one or more primary amines and/or one or more secondary amines of the reacted units of TEPA are covalently bonded to the reacted units of the 3,5-diacrylamidobenzoic acid and/or the reacted units of the methacrylamide.

In some embodiments, the polymer adsorbent is in the form of a cartridge in a water treatment system. The cartridge may be removable from the water treatment system and replaced, washed, and/or reused in the water treatment system as needed. In some embodiments, the polymer adsorbent is in the form of a filter in a water treatment system. The polymer adsorbent may be in the form of a membrane and/or any other shape known in the art for a water treatment plant. In some embodiments, an aqueous solution comprising one or more pollutants flows through the polymer adsorbent in a water treatment system and the one or more pollutants are adsorbed onto the polymer adsorbent. In a preferable embodiment, the membrane is in the form of an open cell or closed cell foam having a density of from 50 to 150 kg/m³, preferably 60 to 120 kg/m³, 70 to 100 kg/m³, or about 85 kg/m³. In an open cell structure, the membrane preferably has a porosity in vol. % of from 50-90 vol. %, preferably 60-75 vol. % or about 50 vol. %.

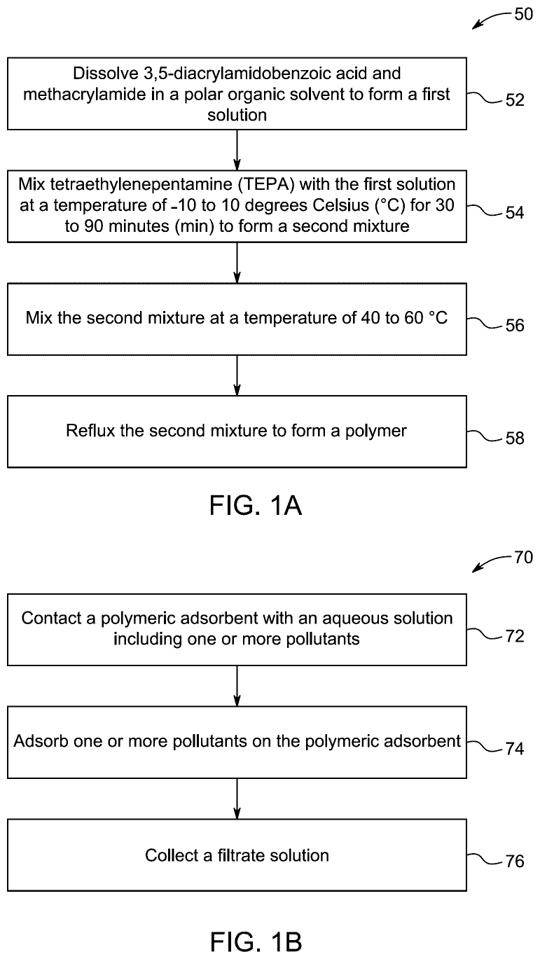

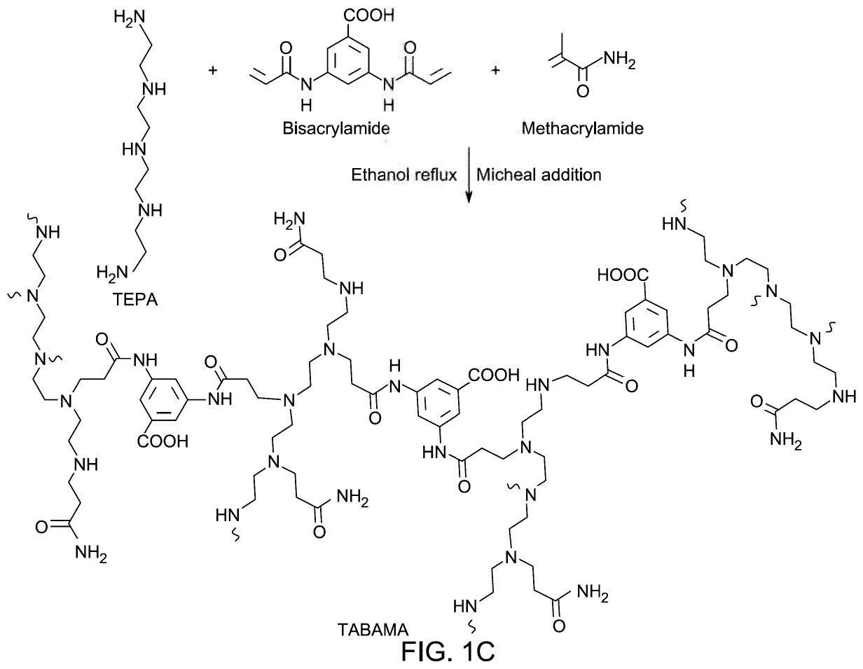

FIG. 1A illustrates a flow chart of a method 50 for making the polymer adsorbent (TABAMA resin). The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes dissolving the 3,5-diacrylamidobenzoic acid and the methacrylamide in a polar organic solvent to form a first solution. Polar organic solvents are organic solvents containing partial positive and partial negative charge. Suitable examples of polar organic solvents include methanol, ethanol, n-propanol, iso-propanol (IPA), n-butanol, iso-butanol, acetone, dimethyl sulfoxide (DMSO), dimethylformamide (DMF), dimethylacetamide (DMA), ethyl acetate, nitromethane, propylene carbonate, tetrahydrofuran (THF), acetonitrile, and mixtures thereof, and the like. In a preferred embodiment, the polar organic solvent is ethanol. In a preferred embodiment, the dissolution of 3,5-diacrylamidobenzoic acid and methacrylamide in the polar organic solvent may be carried out manually, via stirring, or sonication, and/or any methods known in the art.

At step 54, the method 50 includes mixing TEPA with the first solution at a temperature of −10 to 10° C., preferably −9 to 9° C., preferably −8 to 8° C., preferably −7 to 7° C., preferably −6 to 6° C., preferably −5 to 5° C., preferably −4 to 4° C., preferably −3 to 3° C., more preferably −2 to 2° C., and yet more preferably −1 to 1° C. for 30-90 minutes (min), preferably 35-85 min, preferably 40-80 min, preferably 45-75 min, more preferably 50-70 min, and yet more preferably 55-65 min to form a second mixture. In a preferred embodiment, the mixing of the TEPA with the first solution is done at a temperature of 0° C. for 60 min (1 h). The mixing may be carried out manually or with the help of a stirrer. In a preferred embodiment, the mixing was done in an ice bath via stirring. The mixing is performed in an ice bath at 0° C. to control the reaction rate and to manage any potential heat generation during the addition of TEPA. This helps to prevent any uncontrolled reactions or excessive heat generation, which could affect the reaction or cause side reactions. In some embodiments, the mixing is carried out until the particles of TEPA are fully dissolved in the first solution until a homogenous solution is obtained.

At step 56, the method 50 includes mixing the second mixture at a temperature of 40-60° C., preferably 41-59° C., preferably 42-58° C., preferably 43-57° C., preferably 44-56° C., preferably 45-55° C., preferably 46-54° C., preferably 47-53° C., more preferably 48-52° C., and yet more preferably 49-51° C. In a preferred embodiment, the method includes mixing the second mixture at a temperature of 50° C.

At step 58, the method 50 includes refluxing the second mixture to form the polymer. Refluxing is a process that involves vapor condensation and the return of the condensate to the source system. It is used in both industrial and laboratory distillations. Refluxing the second mixture yields the polymer. The resulting polymer was then thoroughly washed to remove any residual impurities or unreacted monomers. The washing may be done by using a solvent like water, alcohol, and/or a mixture thereof. Suitable solvents of alcoholic solvents include methanol, ethanol, isopropanol (IPA), and the like. The water may be tap water, distilled water, bi-distilled water, deionized water, deionized distilled water, reverse osmosis water, and/or any other water. In a preferred embodiment, the washing is done using ethanol and excess deionized water.

In some embodiments, the polymer is porous. A porous polymer is one that forms a porous bulk solid. The pores may be nanopores, micropores, mesopores, macropores, and/or a combination thereof. The pores exist in the bulk material, not necessarily in the molecular structure of the polymer. The term “microporous” refers to a material (the polymer) having pores with an average pore width (i.e. diameter) of less than 2 nm. The term “mesoporous” refers to a material (the polymer) having an average pore width of 2-50 nm. The term “macroporous” refers to a material (the polymer) having an average pore width larger than 50 nm. Pore size may be determined by methods including, but not limited to, gas adsorption (e.g., N₂ adsorption), mercury intrusion porosimetry, and imaging techniques such as scanning electron microscopy (SEM) and X-ray computed tomography (XRCT). In some embodiments, the adsorbent is in the form of particles that are porous and have a pore size of 1-3 nanometers (nm), preferably 1.5-2.5 nm, and more preferably 1.75-2.25 nm. In a preferred embodiment, the adsorbent has a pore size of about 1.92 nm.

The Brunauer-Emmet-Teller (BET) hypothesis is the foundation for an analysis method for determining a material's specific surface area. It explains the physical adsorption of gas molecules on a solid surface. Specific surface area is a property of solids, which is the total surface area of a material per unit of mass, solid or bulk volume, or cross-sectional area. In some embodiments, pore diameter, pore volume, and BET surface area are measured by gas adsorption analysis, preferably N₂ adsorption analysis (e.g., N₂ adsorption isotherms). In some embodiments, the adsorbent is in the form of agglomerates having a longest dimension of 5 to 50 μm, preferably 10 to 45 μm, preferably 15 to 40 μm, preferably 20 to 35 μm, and preferably 25 to 30 μm, made of particles having an average particle size of 25 to 250 nm, preferably 50 to 200 nm, and preferably 100 to 150 nm, and a surface area of 5-15 square meters per gram (m²/g), preferably 6-14 m²/g, preferably 7-13 m²/g, more preferably 8-12 m²/g, and yet more preferably 9-11 m²/g. In a preferred embodiment, the polymer has a surface area of about 10.12 m²/g. In some embodiments, the adsorbent is in the form of particles that are porous and have a pore volume of 0.01-0.1 cubic centimeters per gram (cm³/g), preferably 0.05-0.095 cm³/g, and more preferably 0.075-0.08 cm³/g. In a preferred embodiment, the adsorbent has a pore volume of about 0.041 cm³/g.

In some embodiments, the adsorbent is in the form of particles that are agglomerated and have an average particle size of 50-300 nm, preferably 75-275 nm, preferably 100-250 nm, more preferably 125-225 nm, and yet more preferably 150-200 nm. In alternate embodiments, the adsorbent may exist in different shapes such as a sphere, a rod, a cylinder, a rectangle, a triangle, a pentagon, a hexagon, a prism, a disk, a platelet, a flake, a cube, a cuboid, an urchin, combinations thereof, and the like. Irregular polymer particles feature various shapes, such as confetti-like, code bar-like, raspberry-like, and so on. Regular polymer particles include columns, prisms, disks, ellipsoids, and any other symmetric geometries. As used herein, the term “agglomerated particles” refers to a clustered particulate matter made up of fundamental particles that have been grouped together in a certain manner to create clusters.

FIG. 1B illustrates a flow chart of a method 70 of water treatment. As used herein, water treatment involves employing methods to remove pollutants from contaminated water so that the water meets safety standards for use or environmental release. The order in which the method 70 is described is not intended to be construed as a limitation, and any number of the described method steps can be combined in any order to implement the method 70. Additionally, individual steps may be removed or skipped from the method 70 without departing from the spirit and scope of the present disclosure.

At step 72, the method 70 includes contacting the polymeric adsorbent with an aqueous solution including one or more pollutants. The concentration of the polymeric adsorbent is in a range of 0.1-10 grams per liter (g/L), preferably 0.5-9 g/L, preferably 1-8 g/L, preferably 2-7 g/L, preferably 3-6 g/L, and preferably 4-5 g/L of the aqueous solution. Suitable examples of pollutants include pharmaceutical compounds, heavy metals, organic dyes, and agrochemical pollutants like herbicides, pesticides, and the like.

In some embodiments, the organic pollutant is an organic dye or a dye. A dye is a colored substance that chemically binds to a material it may be intended to color. Examples of dyes include, but are not limited to: acridine dyes, which are acridine and its derivatives such as acridine orange, acridine yellow, acriflavine, and gel green; anthraquinone dyes, which are anthroaquinone and its derivatives such as acid blue 25, alizarin, anthrapurpurin, carminic acid, 1,4-diamno-2,3-dihydroanthraquinone, 7,14-dibenzypyrenequinone, dibromoanthrone, 1,3-dihydroxyanthraquinone, 1,4-dihydroxyanthraquinone, disperse red 9, disperse red 11, indanthrone blue, morindone, oil blue 35, parietin, quinizarine green SS, remazol brilliant blue R, solvent violet 13, 1,2,4-trihydroxyanthraquinone, vat orange 1, and vat yellow 1; diaryl methane dyes such as auramine O, triarylmethane dyes such as acid fuchsin, aluminon, aniline blue WS, aurin, aurintricarboxylic acid, brilliant blue FCF, brilliant green, bromocresol green, bromocresol purple, bromocresol blue, bromophenol blue, bromopyrogallol red, chlorophenol red, coomassie brilliant blue, cresol red, O-cresolphthalein, crystal violet, dichlorofluorescein, ethyl green, fast green FCT, FIAsH-EDT2, fluoran, fuchsine, green S, light green SF, malachite green, merbromin, metacresol purple, methyl blue, methyl violet, naphtholphthalein, new fuchsine, pararosaniline, patent blue V, phenol red, phenolphthalein, phthalein dye, pittacal, spirit blue, thymol blue, thymolphthalein, Victoria blue BO, Victoria blue R, water blue, xylene cyanol, and xylenol orange; azo dyes such as acid orange 5, acid red 13, alican yellow, alizarine yellow R, allura red AC, amaranth, amido black 10B, aniline yellow, arylide yellow, azo violet, azorubine, basic red 18, biebrich scarlet, Bismarck brown Y, black 7984, brilliant black BN, brown FK, chrysoine resorcinol, citrus red 2, congo red, D&C red 33, direct blue 1, disperse orange 1, eriochrome black T, evans blue, fast yellow AB, orange 1, hydroxynaphthol blue, janus green B, lithol rubine BK, metanil yellow, methyl orange, methyl red, methyl yellow, mordant brown 33, mordant red 19, naphthol AS, oil red 0, oil yellow DE, orange B, orange G, orange GGN, para red, pigment yellow 10, ponceau 2R, prontosil, red 2G, scarlet GN, Sirius red, solvent red 26, solvent yellow 124, sudan black B, sudan I, sudan red 7B, sudan stain, tartrazine, tropaeolin, trypan blue, and yellow 2G; phthalocyanine dyes such as phthalocyanine blue BN, phthalocyanine Green G, Alcian blue, and naphthalocyanine, azin dyes such as basic black 2, mauveine, neutral red, Perkin's mauve, phenazine, and safranin; indophenol dyes such as indophenol and dichlorophenolindophenol; oxazin dyes; oxazone dyes; thiazine dyes such as azure A, methylene blue, methylene green, new methylene blue, and toluidine blue; thiazole dyes such as primuline, stains-all, and thioflavin; xanthene dyes such as 6-carboxyfluorescein, eosin B, eosin Y, erythosine, fluorescein, rhodamine B, rose bengal, and Texas red; fluorone dyes such as calcein, carboxyfluorescein diacetate succinimidyl ester, fluo-3, fluo-4, indian yellow, merbromin, pacific blue, phloxine, and seminaphtharhodafluor; or rhodamine dyes such as rhodamine, rhodamine 6G, rhodamine 123, rhodamine B, sulforhodamine 101, and sulforhodamine B; and the like.

In a preferred embodiment, the organic dye is eriochrome black T (EBT) and methyl orange (MO). EBT is a hazardous dye and its intermediate product (naphthoquinone) is carcinogenic. MO is a recalcitrant dye that has carcinogenic and mutagenic effects. MO causes hypersensitivity, allergies, and dermatitis. MO also decreases soil fertility, crop yield, and biodiversity by increasing salinity in soil. The removal of MO and EBT has always been a worldwide concern. The adsorbent of the present disclosure can effectively remove organic dyes present in the aqueous solution at a concentration range of 1-100 milligrams per gram (mg/g), preferably 5-95 mg/g, preferably 10-90 mg/g, preferably 15-85 mg/g, preferably 20-80 mg/g, preferably 25-75 mg/g, preferably 30-70 mg/g, preferably 35-65 mg/g, preferably 40-60 mg/g, and preferably 45-55 mg/g of the aqueous solution. In a preferred embodiment, the adsorbent of the present disclosure can effectively remove organic dyes present in the aqueous solution at a concentration of about 60 mg/g.

In other embodiments, the pollutant is an herbicide. An herbicide (also known as “weed killer”) is a substance that is toxic to plants and may kill, inhibit the growth of, or prevent the germination of plants. Herbicides are typically used to control the growth of or remove unwanted plants from an area of land, particularly in an agricultural context. Examples of herbicides include, but are not limited to, 2,4-D, aminopyralid, chlorsulfuron, clopyralid, dicamba, diuron, glyphosate, hexazinone, imazapic, imazapyr, methsulfuron methyl, picloram, sulfometuron methyl, triclopyr, fenoxaprop, fluazifop, quizalofop, clethodim, sethoxydim, chlorimuron, foramsulfuron, halosulfuron, nicosulfuron, primisulfuron, prosulfuron, rimsulfuron, thofensulfuron, tribenuron, imazamox, imazaquin, flumetsulam, cloransulam, thiencarbazone, fluoxpyr, diflufenzopyr, atrazine, simazine, metribuzin, bromoxynil, bentazon, linuron, glufosinate, clomazone, isoxaflutole, topramezone, mesotrione, tembotrione, acifluorfen, formesafen, lactofen, flumiclorac, flumioxazin, fulfentrazone, carfentrazone, fluthiacet-ethyl, falufenacil, paraquat, ethalfluralin, pendimethalin, trifluralin, butylate, EPTC, ecetochlor, alachlor, metolachlor, dimethenamid, flufenacet, pyroxasulfone, and the like.

In some other embodiments, the pollutant is a pesticide. A pesticide is a substance meant to prevent, destroy, or control pests including, but not limited to algae, bacteria, fungi, plants, insects, mites, snails, rodents, and viruses. A pesticide intended for use against algae is known as an algicide. Examples of algicides include, but are not limited to, benzalkonium chloride, bethoxazin, cybutryne, dichlone, dichlorophen, diuron, endothal, fentin, isoproturon, methabenthiazuron, nabam, oxyfluorfen, pentachlorophenyl laurate, quinoclamine, quinonamid, simazine, terbutryn, tiodonium, and the like.

A pesticide intended for use against bacteria is known as a bactericide. In some embodiments, the pollutant is a bactericide. Examples of bactericides include antibiotics such as: aminoglycosides such as amikacin, gentamicin, kanamycin, neomycin, netilmicin, tobramycin, paromomycin, streptomycin, and spectinomycin; ansamycins such as geldanamycin, herbimycin, and rifaximin; carbacephems such as loracarbef; carbapenems such as ertapenem, doripenem, imipenem, and meropenem; cephalosporins such as cefadroxil, cefazolin, cephradine, cephapirin, cephalothin, cephalexin, cefaclor, cefoxitin, cefotetan, cefamandole, cefmetazole, cefonicid, cefprozil, cefuroxime, cefixime, cefdinir, cefditoren, cefoperazone, cefotaxime, cefpodoxime, cefazidime, ceftibuten, ceftizoxime, moxalactam, ceftriaxone, cefepime, cefaroline fosamil, and ceftobiprole; glycopeptides such as teicoplanin, vancomycin, telavancin, dalbavancin, and oritavancin; lincosamides such as clindamycin and lincomycin; lipopeptides such as daptomycin; macrolides such as azithromycin, clarithromycin, erythromycin, roxithromycin, telithromycin, spiramycin, and fidoxamicin; monobactams such as aztreonam; nitrofurans such as furazolidone and nitrofurantoin; oxazolidinones such as linezolid, posizolid, radezolid, and torezolid; penicillins such as amoxicillin, ampicillin, azlocillin, dicloxacillin, flucloxacillin, mezlocillin, methicillin, nafcillin, oxacillin, penicillins (including penicillin G and V), piperacillin, temocillin, and ticarcillin; polypeptides such as bacitracin, colistin, and polymyxin B; quinolones such as ciproflaxacin, enoxacin, gatifloxacin, gemifloxacin, levofloxacin, lomefloxacin, moxifloxacin, nadifloxacin, nalidixic acid, norfloxacin, ofloxacin, trovafloxacin, gepafloxacin, sparfloxacin, and temafloxacin; sulfonamides such as mafenide, sulfacetamide, sulfadiazine, sulfadithoxine, sulfamethizole, sulfamethoxazole, sulfanilamide, sulfasalazine, sulfisoxazole, and sulfonamidochrysoidine; tetracyclines such as demeclocycline, doxycycline, metacycline, minocycline, oxytetracycline, and tetracycline; and the like.

A pesticide intended for use against fungi is known as a fungicide. In some embodiments, the pollutant is a fungicide. Examples of fungicides include acibenzolar, acypetacs, aldimorph, anilazine, aureofungin, azaconazole, azithiram, azoxystrobin, benalaxyl, benodanil, benomyl, benquinox, benthiavalicarb, binapacryl, biphenyl, bitertanol, bixafen, blasticidin-S, boscalid, bromuconazole, captafol, captan, carbendazim, carboxin, carpropamid, chloroneb, chlorothalonil, chlozolinate, cyazofamid, cymoxanil, cyprodinil, dichlofluanid, diclocymet, dicloran, diethofencarb, difenoconazole, diflumetorim, dimethachlone, dimethomorph, diniconazole, dinocap, dodemorph, edifenphos, enoxastrobin, epoxiconazole, etaconazole, ethaboxam, ethirimol, etridiazole, famoxadone, fenamidone, fenarimol, fenbuconazole, fenfuram, fenhexamid, fenoxanil, fenpropidin, fenpropimorph, ferbam, fluazinam, fludioxonil, flumorph, fluopicolide, fluopyram, fluoroimide, fluoxastrobin, flusilazole, flutianil, flutolain, flopet, fthalide, furalaxyl, guazatine, hexaconazole, hymexazole, imazalil, imibenconazole, iminoctadine, iodocarb, ipconazole, iprobenfos, iprodione, iprovalicarb, siofetamid, isoprothiolane, isotianil, kasugamycin, laminarin, mancozeb, mandestrobin, mandipropamid, maneb, mepanypyrim, mepronil, meptyldinocap, mealaxyl, metominostrobin, metconazole, methafulfocarb, metiram, metrafenone, myclobutanil, naftifine, nuarimol, octhilinone, ofurace, orysastrobin, oxadixyl, oxathiapiprolin, oxolinic acid, oxpoconazole, oxycarboxin, oxytetracycline, pefurazate, penconazole, pencycuron, penflufen, penthiopyrad, phenamacril, picarbutrazox, picoxystrobin, piperalin, polyoxin, probenzole, prochloraz, procymidone, propamocarb, propiconazole, propineb, proquinazid, prothiocarb, prothioconazole, pydiflumetofen, pyraclostrobin, pyrametostrobin, pyraoxystrobin, pyrazophos, pyribencarb, pyributicarb, pyrifenox, pyrimethanil, pyrimorph, pyriofenone, pyroquilon, quinoxyfen, quintozene, sedaxane, silthiofam, simeconazole, spiroxamine, streptomycin, tebuconazole, tebufloquin, teclofthalam, teenazene, terbinafine, tetraconazole, thiabendazole, thifluzamide, thiphanate, thiram, tiadinil, tolclosfos-methyl, folfenpyrid, tolprocarb, tolylfluanid, triadimefon, triadimenol, triazoxide, triclopyricarb, tricyclazole, tridemorph, trifloxystrobin, triflumizole, triforine, validamycin, vinclozolin, and the like.

A pesticide intended for use against plants is known as an herbicide as described above. A pesticide intended for use against insects is known as an insecticide. In some embodiments, the pollutant is an insecticide. Examples of insecticides are: organochlorides such as Aldrin, chlordane, chlordecone, DDT, dieldrin, endofulfan, endrin, heptachlor, hexachlorobenzene, lindane, methoxychlor, mirex, pentachlorophenol, and TDE; organophosphates such as acephate, azinphos-methyl, bensulide, chlorethoxyfos, chlorpyrifos, diazinon, chlorvos, dicrotophos, dimethoate, disulfoton, ethoprop, fenamiphos, fenitrothion, fenthion, malathion, methamdophos, methidathion, mevinphos, monocrotophos, naled, omethoate, oxydemeton-methyl, parathion, phorate, phosalone, phosmet, phostebupirim, phoxim, pirimiphos-methyl, profenofos, terbufos, and trichlorfon; carbamates such as aldicarb, bendiocarb, carbofuran, carbaryl, dioxacarb, fenobucarb, fenoxycarb, isoprocarb, methomyl; pyrethroids such as allethrin, bifenthrin, cyhalothrin, cypermethrin, cyfluthrin, deltamethrin, etofenprox, fenvalerate, permethrin, phenothrin, prallethrin, resmethrin, tetramethrin, tralomethrin, and transfluthrin; neonicotinoids such as acetamiprid, clothiandin, imidacloprid, nithiazine, thiacloprid, and thiamethoxam; ryanoids such as chlorantraniliprole, cyanthaniliprole, and flubendiamide; and the like.

A pesticide intended for use against mites is known as a miticide. In some embodiments, the pollutant is a miticide. Examples of miticides are permethrin, ivermectin, carbamate insecticides as described above, organophosphate insecticides as described above, dicofol, abamectin, chlorfenapyr, cypermethrin, etoxazole, hexythiazox, imidacloprid, propargite, spirotetramat; and the like.

A pesticide intended for use against snails and other mollusks is known as a molluscicide. In some embodiments, the pollutant is a molluscicide. Examples of molluscicides are metaldehyde, methiocarb, and the like.

A pesticide intended for use against rodents is known as a rodenticide. In some embodiments, the pollutant is a rodenticide. Examples of rodenticides are warfarin, coumatetralyl, difenacoum, brodifacoum, flocoumafen, bromadiolone, diphacinone, chlorophacinone, pindone, difethialone, cholecalciferol, ergocalciferol, ANTU, chloralose, crimidine, 1,3-difluoro-2-propanol, endrin, fluroacetamide, phosacetim, pyrinuron, scilliroside, strychnine, tetramethylenedisulfotetramine, bromethalin, 2,4-dinitrophenol, uragan D2, and the like.

A pesticide intended for use against viruses is known as a virucide. In some embodiments, the pollutant is a virucide. Examples of virucides are cyanovirin-N, griffithsin, interferon, NVC-422, scytovirin, urumin, virkon, zonroz, V-bind viricie, and the like.

A persistent organic pollutant is a toxic organic chemical that adversely affects human and environmental health, can be transported by wind and water, and can persist for years, decades, or centuries owing to resistance to environmental degradation by natural chemical, biological, or photolytic processes. In some embodiments, the pollutant is a persistent organic pollutant. Examples of persistent organic pollutants are Aldrin, chlordane, dieldrin, endrin, heptachlor, hexachlorobenzene, mirex, toxaphene, polychlorinated biphenyl (PCBs), dichlorodiphenyltrichloroethane (DDT), dioxins, polychlorinated dibenzofurans, chlordecone, hexachlorocyclohexane (α- and β-), hexabromodiphenyl ether, lindane, pentachlorobenzene, tetrabromodiphenyl ether, perfluorooctanesulfonic acid, endosulfans, hexabromocyclododecane, and the like.

In some embodiments, the pollutant is a pharmaceutical compound. Suitable examples of pharmaceutical compounds include metronidazole, ibuprofen, paracetamol, penicillin, diclofenac, carbamazepine, ofloxacin, norfloxacin, naproxen, ciprofloxacin, amoxicillin, azithromycin, and the like. In some embodiments, the pollutant is an agrochemical. Suitable examples of agrochemical pollutants include fipronil, thiamethoxam, atrazine, dichloro-diphenyl-trichloroethane (DDT), imidacloprid, thiacloprid, acetamiprid, clothianidin, nitenpyram, dinotefuran, and the like.

In some embodiments, the pollutant is a heavy metal. Heavy metals are generally classified by their high density and atomic weight. Additionally, certain elements, including metalloids exhibiting high toxicity to both humans and the environment, are also included in heavy metals. These heavy metals enter into various environmental areas through natural and anthropogenic sources, ultimately finding their way into the human body through the food chain. Typically, heavy metal concentrations in natural water bodies are relatively low; however, even at lower concentrations, certain heavy metals can pose severe health risks. The most concern arises when industrial facilities discharge metal-contaminated effluents and wastewater into freshwater bodies without adequate treatment. This indiscriminate release further intensifies the contamination issue and poses a serious threat to the environment.

Suitable examples of heavy metal ions that can be adsorbed by the polymer of the present disclosure are of a wide range and include, but are not limited to, ions of lead (Pb), mercury (Hg), cadmium (Cd), chromium (Cr), arsenic (As). Further, these metal ions may be of any oxidation state M¹⁺, M²⁺, M³⁺, and the like. Exemplary additional metal ions include, but are not limited to, Ag, Na, Li, Mn, Fe, Co, Ni, Cu, Sn, Fe, As, Sb, Zn, V, Pt, Pd, Rh, Al, and mixtures thereof, and the like in various oxidation states such as +1, +2 and +3. In a preferred embodiment, the metal ions are Cd, Pb, and Cr. The concentration of the metal ions is in a range of 1-200 milligrams per liter (mg/L), preferably 50-150 mg/L, and more preferably about 100 mg/L of the aqueous solution. In some embodiments, the concentration of the metal ions may be of any amount.

The current method can be applied to various water sources and systems. Water sources refer to natural or artificial locations where water is obtained, such as rivers, lakes, reservoirs, groundwater aquifers, rainwater collection systems, and the like. Water systems are the infrastructure and processes used to treat, store, and distribute water, including treatment facilities, pipelines, storage tanks, and the like. Example of water sources and systems include, but are not limited to, runoff, surface water (such as from streams, creeks, rivers, lakes, reservoirs, or oceans), groundwater from aquifers, industrial wastewater, and public water storage tanks. Water treatment can be done in tanks, containers, or small-scale setups using batch mode, fixed-bed mode, or column mode. At step 74, the method 70 includes adsorbing one or more pollutants on the polymeric adsorbent. Adsorption is a mechanism of removing the pollutant in the present disclosure, which refers to contact between the adsorbent material (polymer) and the target adsorbate (pollutants like organic dyes, heavy metal ions). A factor that affects the removal efficiency of the polymeric adsorbent is the agitation speed of the adsorbent material and the adsorbate. Removal efficiency improves with agitation speed due to better mixing and faster contact between contaminants and the adsorbent enhance the process; however, efficiency can drop if agitation is too high due to excessive turbulence or damage. The agitation may be done via shaking, stirring, rotating, vibrating, sonication, mechanical shaker, and any methods known in the art.

In the present disclosure, the adsorption may be chemisorption, physisorption, or mixtures thereof. In an embodiment, the organic dyes and/or metal ions may be removed from the aqueous solution by physisorption with the polymer. In another embodiment, the organic dyes may interact with the surface and/or the pores of the polymer via hydrogen bonding interactions, van der Waals forces, and/or π-π stacking.

In some embodiments, the one or more pollutants are one or more metal ions, and the one or more metal ions are adsorbed onto the polymeric adsorbent through metal-ligand complexation with one or more amines of the reacted units of the TEPA and the reacted units of the methacrylamide. The pollutants are adsorbed onto the polymeric adsorbent through electrostatic interactions with one or more oxygen-containing functional groups of the reacted units of the 3,5-diacrylamidobenzoic acid and the reacted units of the methacrylamide. In a preferred embodiment, the one or more pollutants are one or more metal ions.

In some embodiments, carboxylic acid functional groups in the reacted units of the 3,5-diacrylamidobenzoic acid do not react with reacted units of the TEPA.

In some embodiments, the adsorbent has an adsorption capacity of 58-64 mg/g, preferably 59-63 mg/g, and more preferably 60-62 mg/g for Cd ions. In a preferred embodiment, the adsorbent has an adsorption capacity of about 60.98 mg/g for Cd ions. In some embodiments, the adsorbent has an adsorption capacity of 116-122 mg/g, preferably 117-121 mg/g, and more preferably 118-120 mg/g for Cr ions. In a preferred embodiment, the adsorbent has an adsorption capacity of about 119 mg/g for Cr ions. In some embodiments, the adsorbent has an adsorption capacity of 5-15 mg/g, preferably 6-14 mg/g, preferably 7-13 mg/g, more preferably 8-12 mg/g, and yet more preferably 9-11 mg/g for Pb ions. In a preferred embodiment, the adsorbent has an adsorption capacity of about 9.30 mg/g for Pb ions.

In some embodiments, the adsorbent has a dye removal efficiency for EBT of at least 99%, preferably 99.1%, preferably 99.3%, preferably 99.5%, preferably 99.7%, and preferably 99.9% based on an initial amount of the EBT. In some embodiments, the adsorbent has a dye removal efficiency for MO of 35-45%, preferably 36-44%, preferably 37-43%, more preferably 38-42%, and yet more preferably 39-41% based on an initial amount of the MO. In a preferred embodiment, the adsorbent has a dye removal efficiency for MO is about 40%.

At step 76, the method 70 includes collecting a filtrate solution. In some embodiments, the pollutant-loaded polymeric adsorbent is obtained from the aqueous solution via filtration, centrifugation, evaporation, or heated evaporation. In some embodiments, the filtrate solution has fewer pollutants than the aqueous solution. The concentration of the pollutants is reduced by adsorption on the surface of the polymeric adsorbent.

In some embodiments, the method 70 further includes washing and drying the polymeric adsorbent after the contacting to regenerate the polymeric adsorbent. The pollutant-loaded polymeric adsorbent can be recycled, regenerated, and/or reused by washing with a solvent like water, alcohol, or a mixture thereof. Washing helps to remove contaminants and restore the adsorbent's effectiveness for reuse. Suitable solvents of alcoholic solvents include methanol, ethanol, n-propanol, n-butanol, iso-butanol, IPA, and the like. The water may be tap water, distilled water, bi-distilled water, deionized water, deionized distilled water, reverse osmosis water, and/or some other water. In a preferred embodiment, the washing may be done using deionized water. The washed polymer is further dried using heating appliances such as hot plates, heating mantles, ovens, microwaves, autoclaves, tapes, oil baths, salt baths, sand baths, air baths, hot-tube furnaces, hot-air guns, and the like.

In some embodiments, the method 70 further includes contacting the regenerated polymeric adsorbent with an aqueous solution including one or more pollutants. The method further includes adsorbing the one or more pollutants on the regenerated polymeric adsorbent. The reaction may be repeated for one cycle, preferably two cycles, and more preferably three cycles. In some embodiments, adsorption of the one or more pollutants occurs in less than 10 minutes, preferably 9 minutes, preferably 8 minutes, preferably 7 minutes, preferably 6 minutes, preferably 5 minutes, preferably 4 minutes, preferably 3 minutes, preferably 2 minutes, and preferably 1 minute. In some embodiments, the regenerated polymeric adsorbent has a removal efficiency of one or more pollutants of at least 50%, preferably 55%, preferably 60%, preferably 65%, preferably 70%, preferably 75%, preferably 80%, preferably 85%, preferably 90%, and preferably >95% based on an initial amount of the one or more pollutants in the aqueous solution.

### EXAMPLES

The following examples describe and demonstrate a hyper-cross-linked polyamide/polyamine three-dimensional (3D) network (TABAMA resin) for water treatment. The examples are provided solely for illustration and are not to be construed as limitations of the present disclosure, as many variations thereof are possible without departing from the spirit and scope of the present disclosure.

### Example 1: Chemicals, Reagents, and Equipment

Tetraethylenepentamine (TEPA), absolute ethanol (95.0%), methacrylamide (98.0%), eriochrome black T (EBT) (indicator grade), and methyl orange (MO) (85.0%) were purchased from Sigma-Aldrich (USA). Bisacrylamide was synthesized by following the procedure reported in literature [Waheed, A., Mansha, M., Kazi, I. W., Ullah, N., 2019. Synthesis of a novel 3,5-diacrylamidobenzoic acid based hyper-cross-linked resin for the efficient adsorption of Congo Red and Rhodamine B. J Hazard Mater 369, 528-538, which is incorporated herein by reference in its entirety]. Ultrapure deionized water was collected using Pure lab Option-Q provided by ELGA (United Kingdom). Nitric acid (HNO₃) (70%) was obtained from Sigma-Aldrich, USA, and further purified using acid distillation. A pH meter purchased from Fisher Scientific Accumet, USA, was used for the pH measurement during experiments. Sodium hydroxide (NaOH) (97%) was purchased from BDH Chemicals Ltd., UK.

### Example 2: Synthesis of TABAMA Resin

The TABAMA resin was synthesized through a single-step Michael addition reaction. TEPA was used as a Michael donor having multiple amino functions per molecule and the bisacrylamide was used as a Michael acceptor having α- and β-unsaturated functional groups. In the presence of ethanol as a proton source, the reaction proceeds under reflux conditions, yielding TABAMA resin as an adduct of Michael addition. 6.5 grams (g) (3.0 eq., 0.0317 moles) of bisacrylamide and 1.8 g (2.0 eq., 0.0211 moles) of methacrylamide were dissolved in absolute ethanol (150 milliliters (mL)) in a round bottom flask. The flask was transferred to an ice bath., 2 g (1 eq. 0.0105 moles) of TEPA was added dropwise to the flask. The reaction was allowed to proceed at 0° C. for 1 hour (h). The flask was raised to 50° C. after solids appeared in the flask at 0° C. Finally, the reaction was heated to reflux, yielding a crosslinked resin, which was thoroughly washed with ethanol and in excess with deionized water. The resultant resin was dried in a freeze dryer, yielding a highly fluffy and lightweight yellowish-brown powder named TABAMA. The reaction conditions for Michael addition and structure of TABAMA resin are presented in FIG. 1C.

### Example 3: Characterization of the Synthesized Adsorbents

To determine different functional groups located in the structure of the synthesized hyper-cross-linked mesoporous resin, attenuated total reflectance Fourier transform infrared spectroscopy (ATR-FTIR) (ATR-FTIR, Nicolet iS-50, Thermo Fisher Scientific) was performed using a potassium bromide (KBr) disc prepared with a few milligrams of the resin. Similarly, crystallinity and/or amorphousness of the resin was determined by using wide angle powder X-ray diffraction (PXRD, MiniFlex-600, Rigaku), in which 20 vs. intensity values were recorded with powdered samples of the resin loaded on the stage of machine. Thermal stability of the synthesized hyper-cross-linked resin was studied by thermogravimetric analysis (TGA) using a DSC SDT Q600 thermogravimetric analyzer by TA Instruments under air conditions at a heating rate of 10 degrees Celsius per minute (° C./min). The surface area and porosity of the polymer were studied by the Brunauer-Emmett-Teller (BET) surface area analyzer. The surface morphology and different surface features of the synthesized resin were studied by scanning electron microscopy (SEM) (SEM/EDX, Coxem EM-30AX SEM), where the resin samples were coated in gold before investigation. Elemental composition and distribution of elements in the structure of the synthesized mesoporous hyper-crosslinked resin were studied by energy dispersive X-ray analysis and mapping analysis, respectively (SEM/EDX, Coxem EM-30AX SEM). To observe structural features and support the arrangement of different layers in the structure of the synthesized resin, transmission electron microscopy TEM (FE-TEM, JEM2100F, JEOL) of the resin was also carried out. Similar characterizations were also performed for the resin after metal and dye adsorption. During the TEM measurements, selected area electron diffraction (SAED) patterns of the resin were also recorded to determine fringe patterns in the structure of the resin. The presence of metal ions of different sizes was also confirmed through TEM measurements and SAED patterns. UV-visible spectrometry was also performed to measure the concentration of dyes, such as EBT and MO, in the solution before and after absorption experiments.

### Example 4: Adsorption Experiments

Adsorption experiments were performed by preparing standard solutions containing a mixture of cadmium (Cd), chromium (Cr), and lead (Pb). A dosage of adsorbent was added into the flask containing a standard or sample solution. The adsorption was assisted by shaking the solutions on a mechanical shaker for a certain amount of time. The adsorbent was then separated from the solution by filtration and the remaining concentration of metals in the solution was analyzed by inductively coupled plasma atomic emission spectroscopy (ICP-AES), Perkin Elmer Optima 8000. The plasma, auxiliary, and nebulizer gas flow rates were maintained at 10 L·min⁻¹, 0.2 L·min⁻¹, and 0.7 L·min⁻¹, respectively. Radiofrequency (RF) power was set at 1350 watts. Measurements were taken using axial mode of plasma view and the read delay was set at 60 seconds. The peristaltic pump flow was maintained at 1.5 mL·min⁻¹. A cyclonic spray chamber, Mira Mist nebulizer, alumina injector, and quartz torch with a single slot were employed. The measurements of the metals were performed at the following wavelengths (nm): Cd: 214.440; Cr: 267.716; and Pb: 220.353. The effect of various parameters, such as pH of the solution, adsorbent dosage, adsorbate concentration, and adsorption time, on the adsorption process was investigated. The percentage removal and adsorption capacity were determined using Eq. 1 and Eq. 2, respectively [Naseem, K., Begum, R., Wu, W., Usman, M., Irfan, A., Al-Sehemi, A. G., Farooqi, Z. H., Adsorptive removal of heavy metal ions using polystyrene-poly(N-isopropylmethacrylamide-acrylic acid) core/shell gel particles: Adsorption isotherms and kinetic study. J. Mol. Liq. 277, 2019, 522-531, which is incorporated herein by reference in its entirety].

$$Percentage removal = \frac{( ci - c f )}{ci} \times 100 \qquad ( 1 )$$

$$Qe = \frac{V ( C i - C e )}{m} \qquad ( 2 )$$

where Cᵢ is the initial concentration of the adsorbate, Cf is the final concentration of adsorbate, Cₑ is the equilibrium concentration of adsorbate in mg·L⁻¹, Qₑ is adsorption capacity in milligrams per gram (mg/g), V is the volume of the solution in liters, and m is the mass of adsorbent in grams.

### Results and Discussion

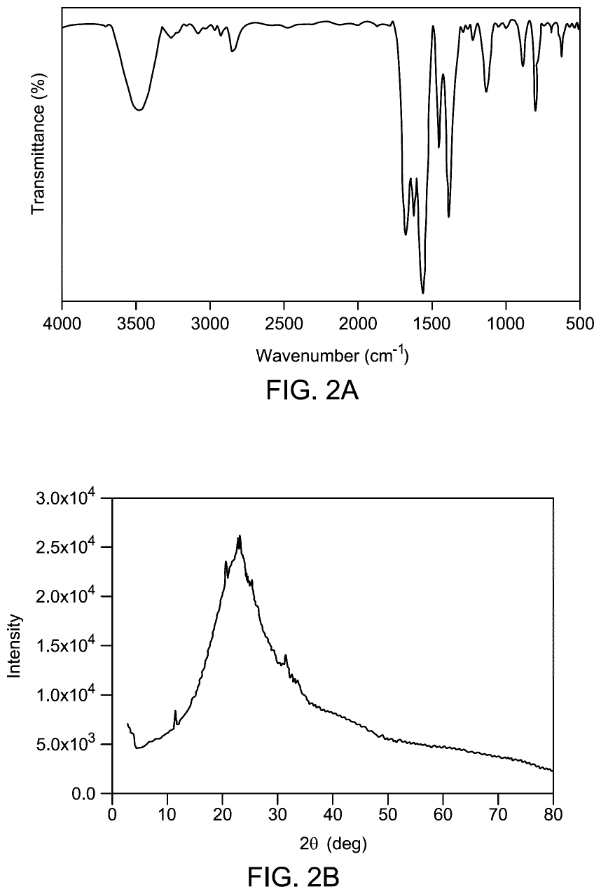

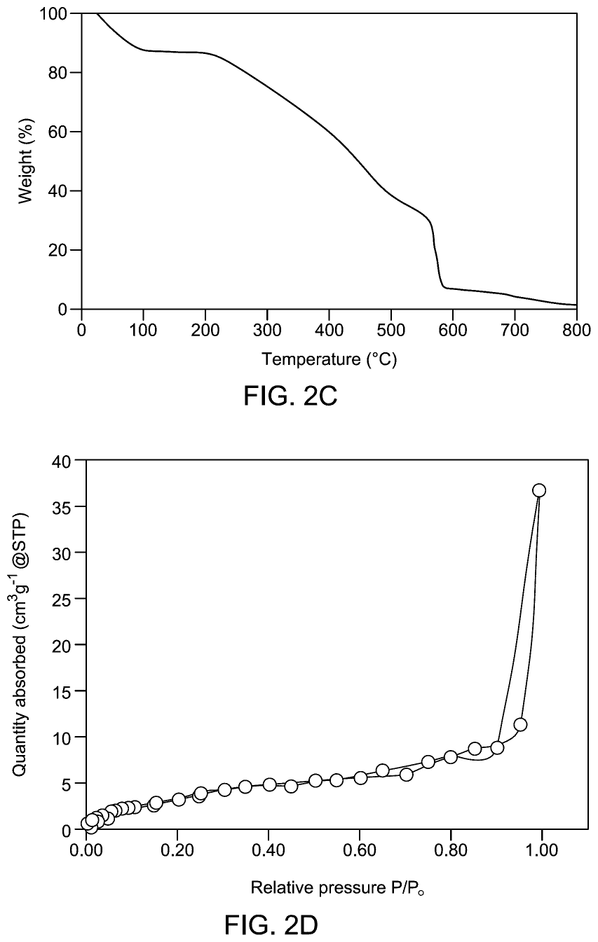

The presence of different functional groups in the structure of the synthesized resin was confirmed through the FTIR spectrum. The resin is composed of different components such as TEPA, 3,5-bisacrylamide containing benzoic acid, and acrylamide monomer. The structure of resin is composed of random co-polymer-containing polyamide and polyamine regions. Therefore, a broad peak spanning from 3600 cm⁻¹ to 3300 cm⁻¹ is attributed to the N—H stretching of polyamide overlapping polyamine functional groups with contribution from —COOH groups of benzoic acid moiety of the resin. Similarly, a peak at around 3000 cm⁻¹ can be attributed to the C—H bond stretching of aromatic rings of the benzoic acid functional group. The other two peaks located at around 2900 cm⁻¹ are due to aliphatic CH₂ groups of TEPA. The peaks at 1700 cm⁻¹ and 1600 cm⁻¹ are due to C═O and C═C stretching vibrations, whereas the peak at 1550 cm⁻¹ is due to in-plane N—H bending (FIG. 2A). The presence of the characteristic peaks in the FTIR spectrum of the resin supports the effective contribution of the reacting monomers toward the structure of the resin and the successful synthesis of the resin. Similar to FTIR, PXRD of the resin was also recorded, as shown in FIG. 2B. The PXRD pattern showed generally an amorphous pattern with a limited level of crystallinity. The huge hump spanning from 2θ of 10° to 50° is attributed to the amorphous nature of the resin, which is also observed in the flexible structure of the resin. Unlike COFs and MOFs, polymeric resins lack definite planes and phases as there is a lack of rigidity found in the structure of the reacting monomers; however, certain sharp peaks distributed in the PXRD pattern, such as peaks at 2θ=12°, 20°, 25°, 27°, and 32° (FIG. 2B) suggest the existence of a level of crystallinity due to the presence of planes in the structure of the resin.

Thermal stability of the synthesized resin was studied using TGA/DSC analysis. A look at the TGA curve shows regions of degradation as the temperature is gradually raised from 0° C. to 800° C. (FIG. 2C). A sharp dip is present at the beginning of the curve, especially up to 100° C., which is due to rapid loss of water molecules entrapped in the pores of the resin, supporting the porous nature of the resin. From 100° C. to 250° C., there was no appreciable loss in the mass of the resin. A loss in mass of the resin was observed as the temperature was raised from 300° C. to 550° C., which is due to the thermolysis of the resin accounting for a 90% loss in mass of the resin. The remaining 10% loss in mass of the resin at a temperature >600° C. is due to carbonization of the resin. BET analysis of the resin was carried out to determine surface area and pore size of the resin. The surface area of the material was found to be 10.12 square meters per gram (m²/g) with a pore volume of 4.1×10⁻² cubic centimeters per gram (cm³/g) and a pore size of 1.92 nanometers (nm). The pore size in the range of 1.92 nm indicates that the synthesized resin is mesoporous in nature. Furthermore, the type II adsorption-desorption isotherm also supports the mesoporous nature of the resin with a narrow hysteresis loop, which closes at a relative pressure of 0.06 (FIG. 2D).

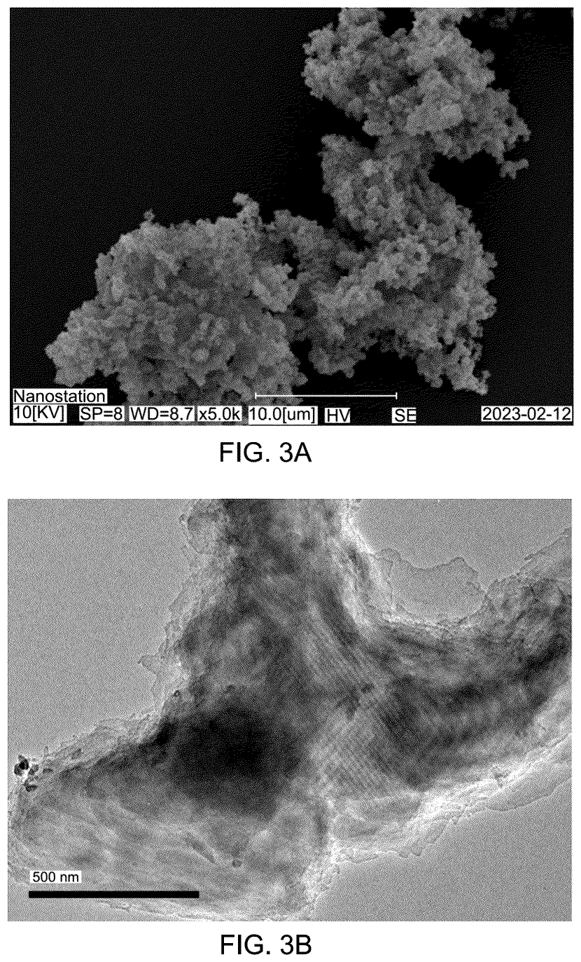

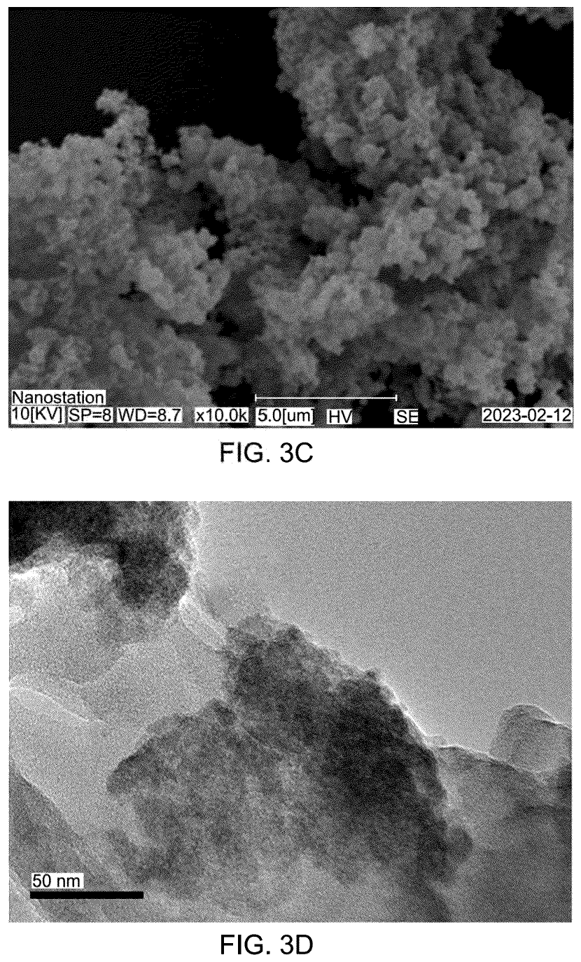

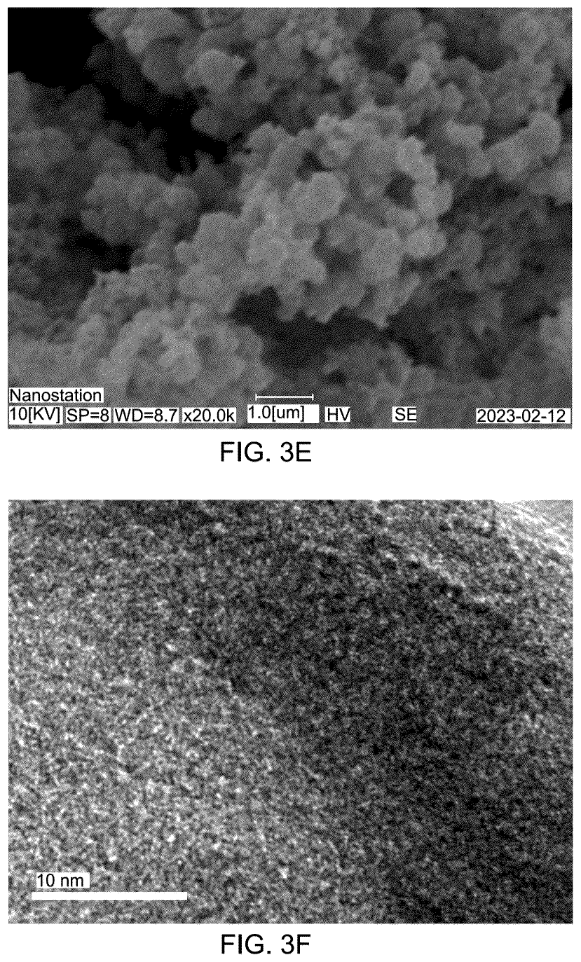

The SEM micrographs (FIG. 3A, FIG. 3C, and FIG. 3E) of the resin revealed a highly porous and spongy nature of the resin. The resin is in the form of agglomerates having a size of 5-50 μm made of uniformly distributed particles of an average particle size in the range of 100 nm to 200 nm, which appear to be fused in certain regions of the resin. The structure of the resin has several functional groups, which include —COOH, —NH, —NH₂, —CONH, and benzene rings, which can develop interactions between neighboring resin chains. This is also seen in HR-TEM micrographs of the resin shown in FIG. 3B, FIG. 3D, and FIG. 3F. It can be seen in FIG. 3B that the layers of the resin are overlapping and lying on each other, and that pattern continues to the edges of the resin. At higher resolutions, the particle layers along with some regions of spongy clusters become more vivid. At a scale of 10 nm, the material appears to be highly porous with the uniform existence of pores throughout the entire structure of the resin (FIG. 3F). Hence, the morphological features of the resin are beneficial for a material to have good adsorption potential for different analytes.

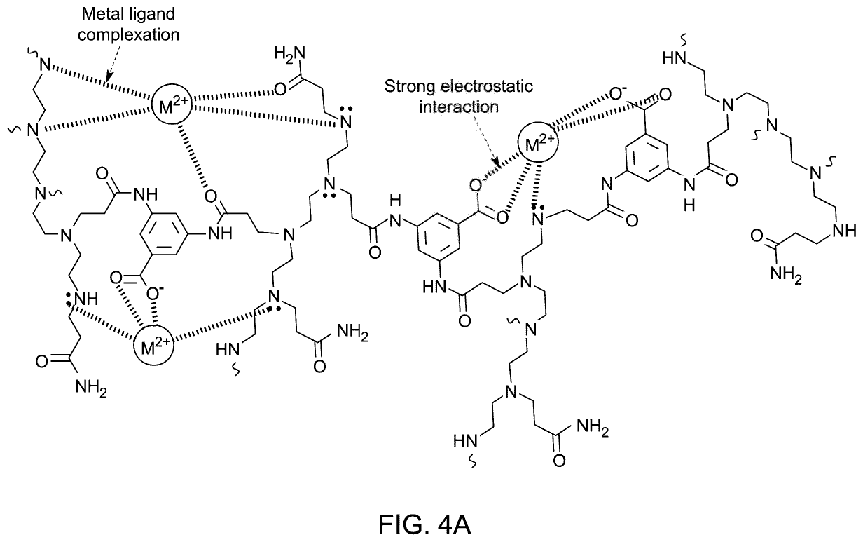

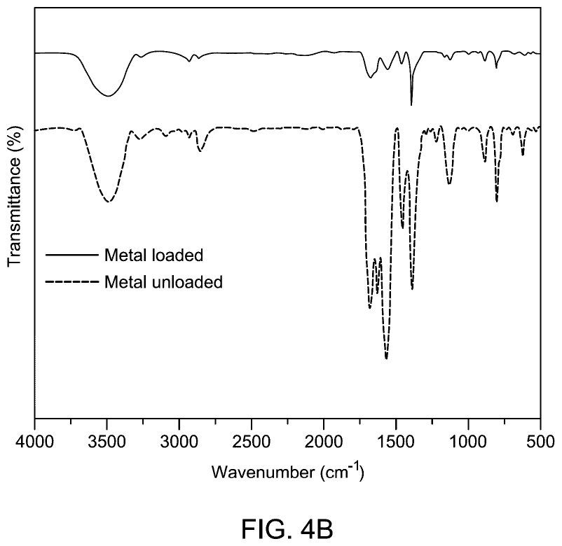

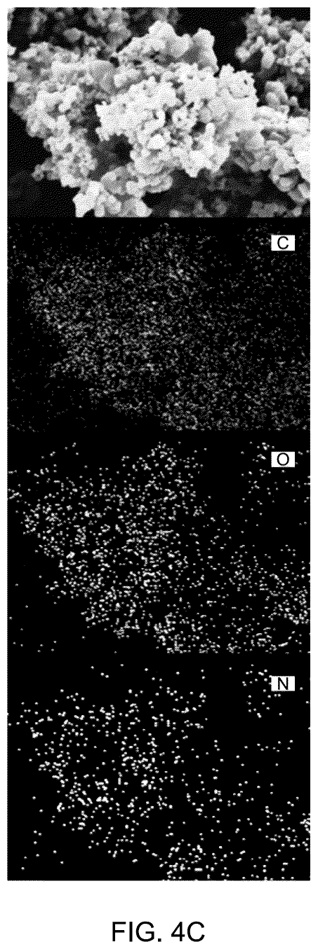

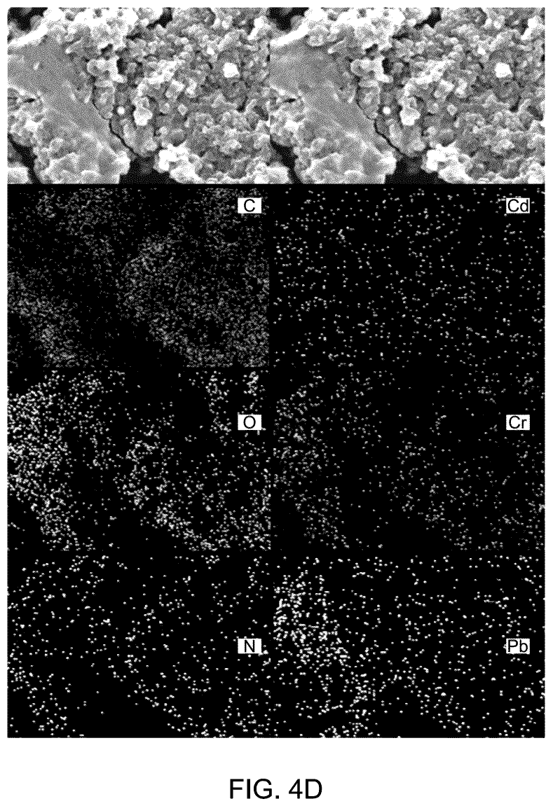

After establishing and exploring the structural features of the synthesized resin, the adsorptive potential of the polymer for heavy metal ions was determined. Heavy metals, such as cadmium (Cd), chromium (Cr), and lead (Pb), are highly toxic to not only aquatic life but also to human beings. Removing these heavy metals is beneficial for the health and sustainability of aquatic ecosystems and human well-being. Metal ions are positively charged and can develop several interactions with the functional groups of the resin. The possible interactions of the resin with the metal ions are shown in FIG. 4A. FTIR analysis of the unloaded and metal-loaded TABAMA resin showed that the intensity of the peaks lowered upon loading of metal ions on/in the resin. This observation indicates that there is a strong interaction between the metal ions and TABAMA resin. The peak at around 3500 cm⁻¹ became less intense after the loading of metal ions indicating that the —NH groups of amides (—CONH) and amines are engaged in coordinating with the metal ions. Similarly, the —OH group of —COOH groups of diaminobenzoic acid also lies in the region of 3500 cm⁻¹ which can develop forces of interaction with the metal ions. Further support of coordination of —CONH and —COOH groups comes from the reduction in the intensity of the carbonyl (>C═O) peak at 1700 cm⁻¹, which shows that the >C═O is also involved in coordinating with the metal ions. Similarly, the peak at 1550 cm⁻¹ is also reduced, which further supports the binding of N—H with metal ions (FIG. 4B). The decrease in intensities of the peaks show that TABAMA resin is occupied by the metal ions which led to a decrease in the available functional groups for detection by FTIR spectroscopy.

Elemental mapping analysis, by way of EDX analysis, was performed to further explore the way metals have been absorbed by the TABAMA resin. In the case of unloaded TABAMA resin (FIG. 4C), carbon (C), oxygen (O), and nitrogen (N) were found to be uniformly distributed over the entire mass of the resin. The metal-loaded TABAMA resin showed additional elements, which were heavy metals adsorbed by the resin. The metal-loaded TABAMA resin had Cd, Cr, and Pb in addition to C, O, and N (FIG. 4D). Another observation of mapping analysis was the density of the heavy metal ions adsorbed by TABAMA resin. The density of the metal ions was like that of the constituent elements of TABAMA resin. The Cr metal ion showed the highest density of particles, indicating that Cr was adsorbed by the TABAMA resin.

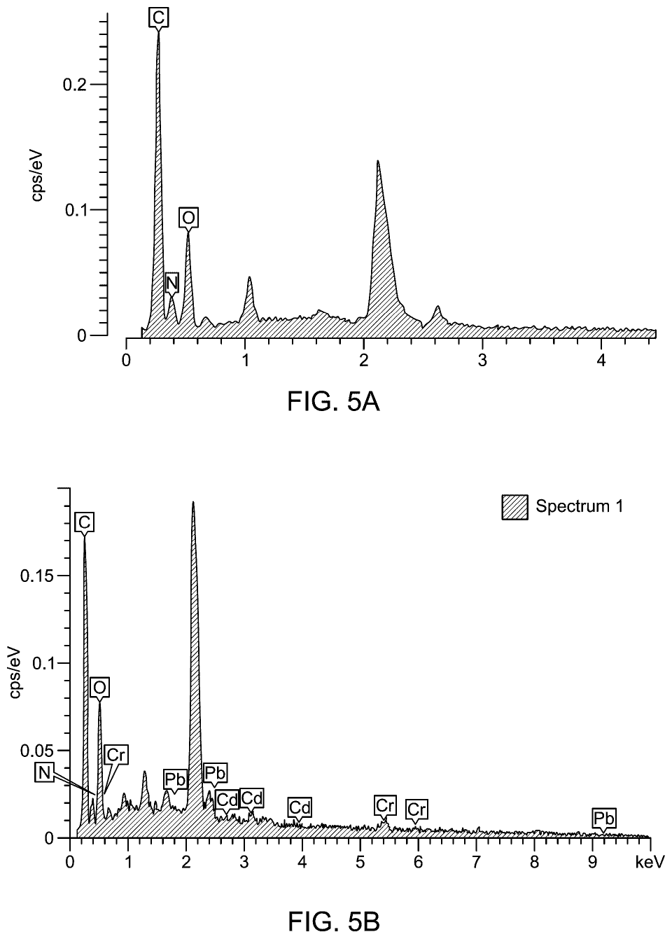

Another useful characterization of unloaded and metal-loaded TABAMA is the analysis of its elemental composition by EDX analysis. EDX analysis shows all elements that are present based on their molecular structure. The elements found in TABAMA were carbon (C), oxygen (O), and nitrogen (N), as shown in FIG. 5A. Upon adsorption of metal ions by TABAMA, the EDX analysis of the resin showed peaks for the adsorbed heavy metal ions, which were lead (Pb), chromium (Cr), and cadmium (Cd), as shown in FIG. 5B.

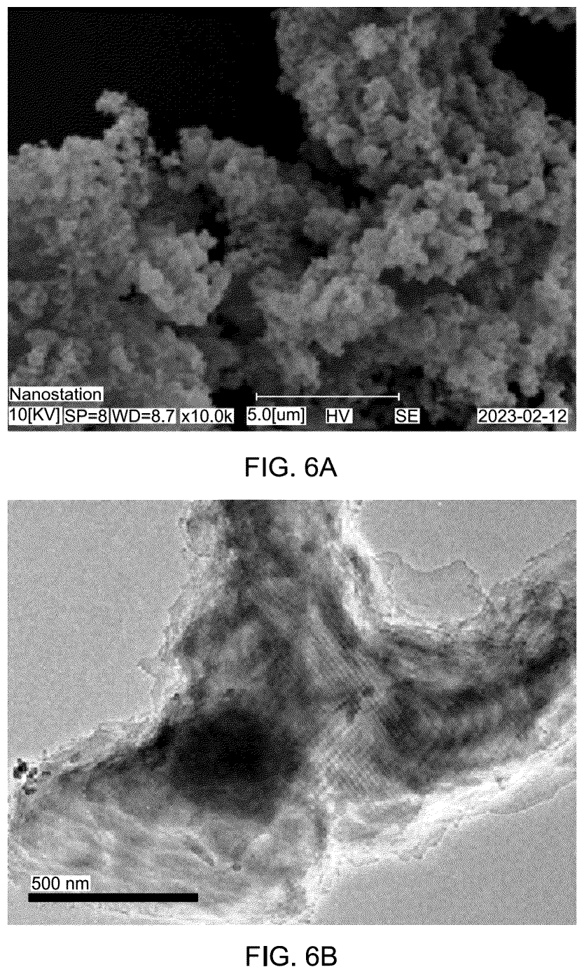

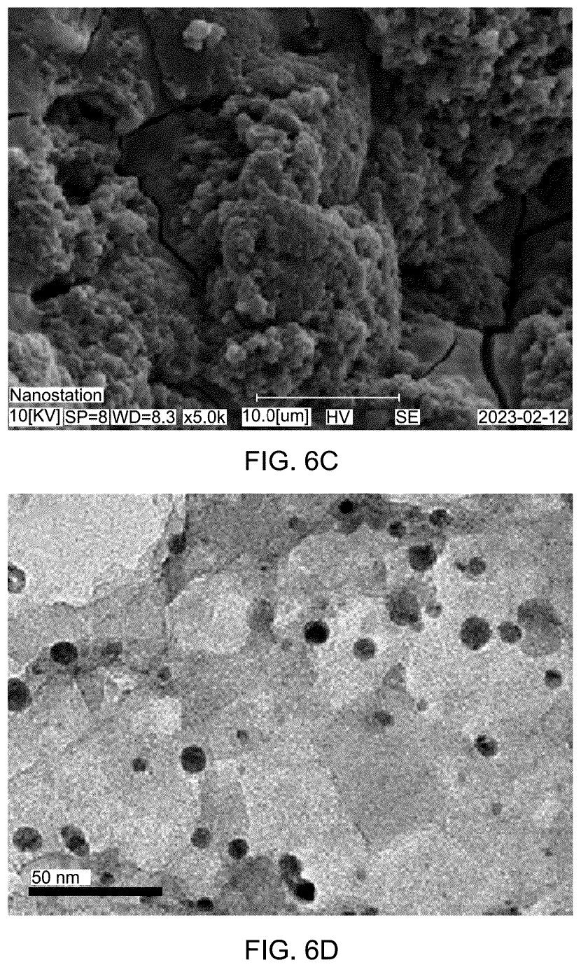

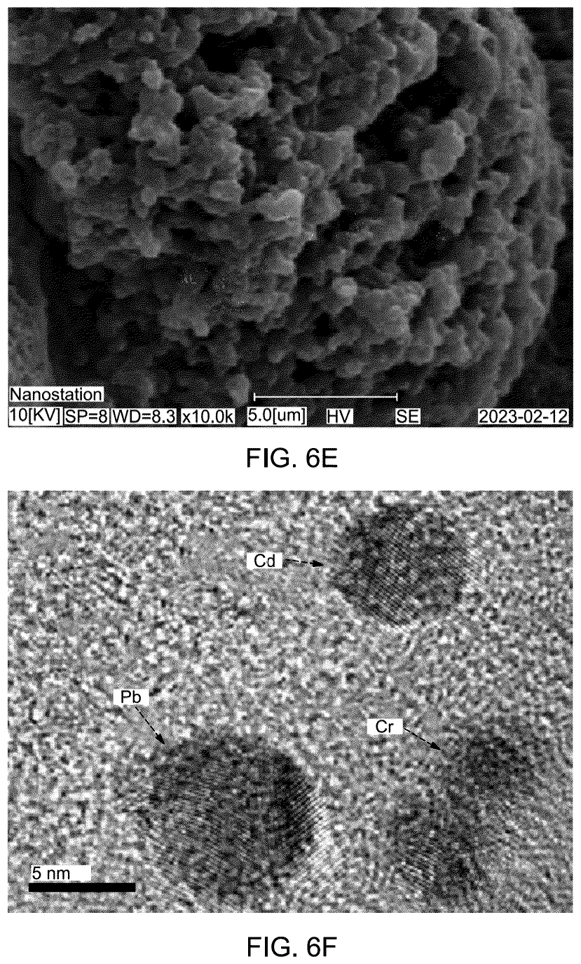

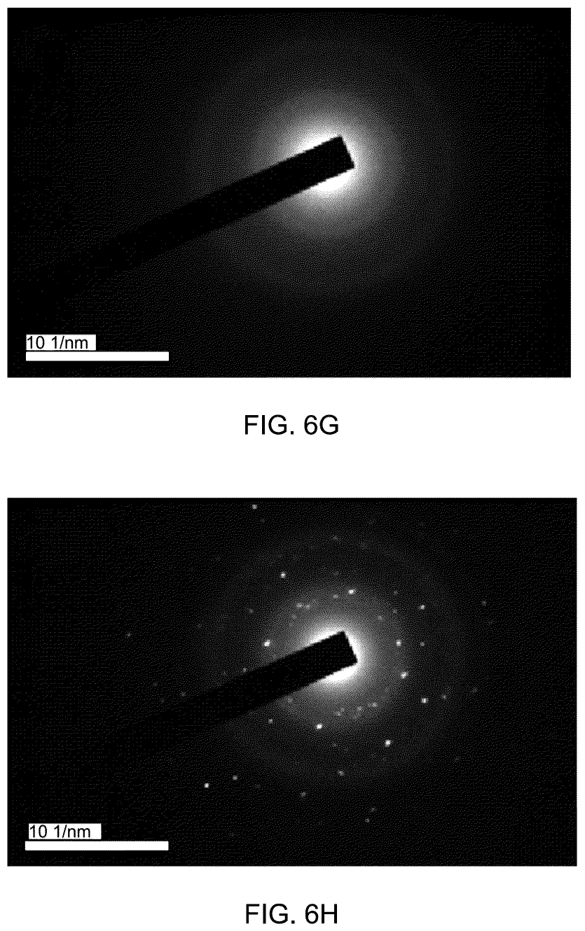

SEM micrographs of the unloaded and metal-loaded TABAMA resin were also recorded to understand the adsorption of heavy metal ions on the resins. TABAMA is porous with a smooth surface and uniformly distributed particles (FIG. 6A); however, upon adsorption of metal ions, the surface appearance of TABAMA was altered, as seen in FIG. 6C and FIG. 6E. The TABAMA particles appeared agglomerated upon the adsorption of metal ions. The metal ions develop an interaction with the resin, leading to an alteration in the morphology of the resin (FIG. 6C and FIG. 6E). The adsorption of heavy metals is also observed in TEM analysis of the resin. The analysis of the HR-TEM micrographs of unloaded and metal-loaded TABAMA resin showed a clear difference. In the case of unloaded resin, the TEM image showed layers of the resin laying on each other without any evidence of impregnation of spots (FIG. 6B). As the metal ions are adsorbed by the resin, the TEM image shows the presence of a variety of spots that were impregnated onto the resin. Three different sized metal particles were found in the TEM image of the metal-loaded TABAMA (FIG. 6D). The different sizes of the impregnated spots are related to the atomic size of the heavy metal ions. Pb (175 μm), Cd (149 μm), and Cr (125 μm) can be identified from the high-resolution transmission electron microscopy (HR-TEM) of the metal-loaded TABAMA (FIG. 6F). Furthermore, the selected area electron diffraction (SAED) patterns of unloaded and metal-loaded resin were also compared, which revealed the presence of planes arranged in a circular manner. This pattern shows that the resin possesses a certain degree of crystallinity, which was also detected by PXRD (FIG. 2B). In addition to planes, the SAED pattern of metal loaded TABAMA resin has several spots arranged between the layers and on the entire area of the resin (FIG. 6H). On the other hand, the SAED pattern of unloaded resin does not have any metallic spots (FIG. 6G).

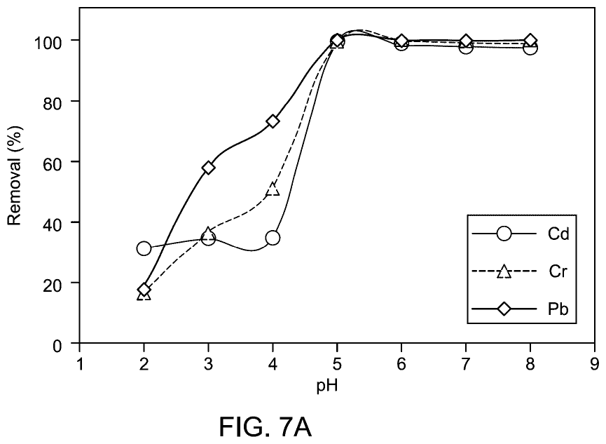

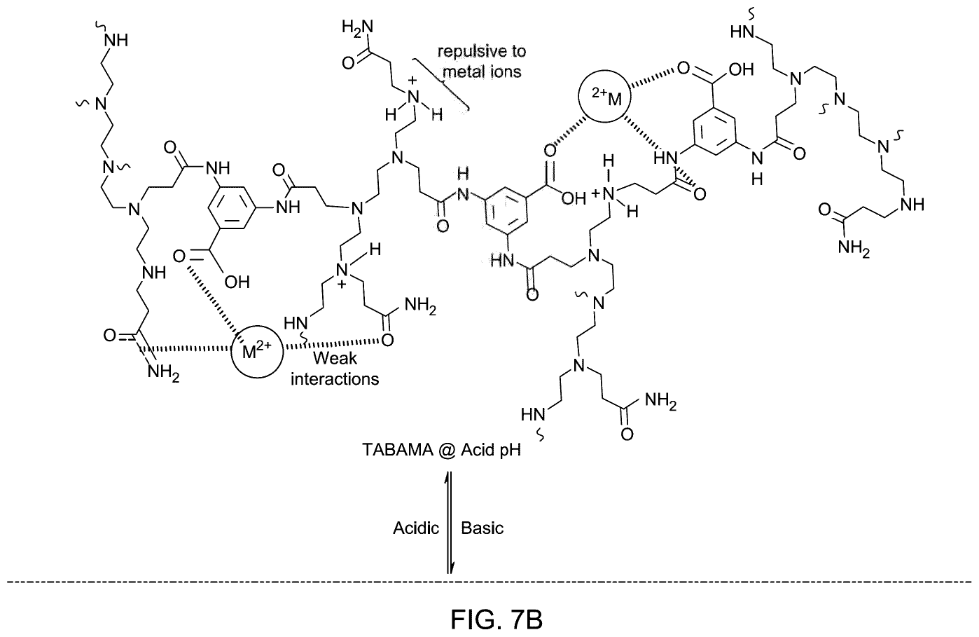

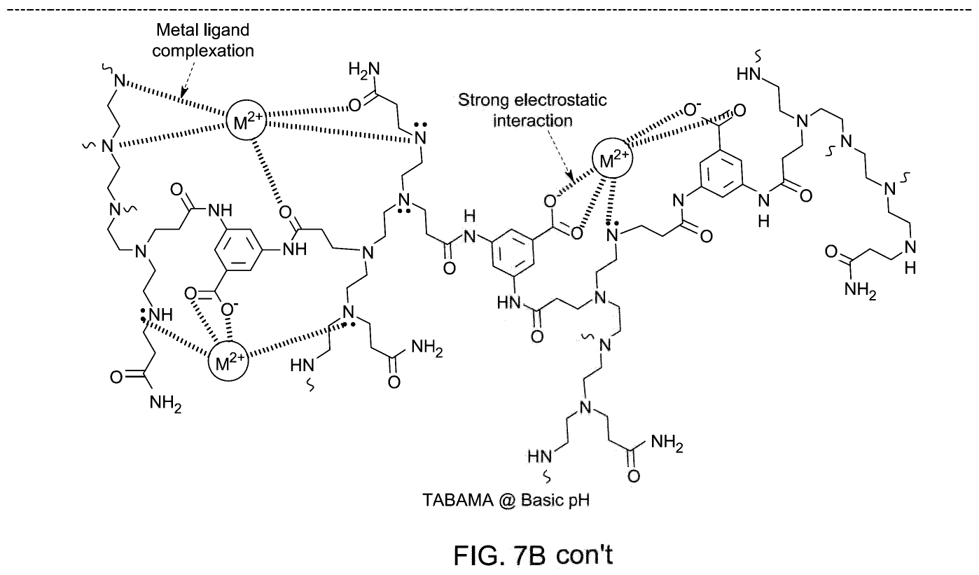

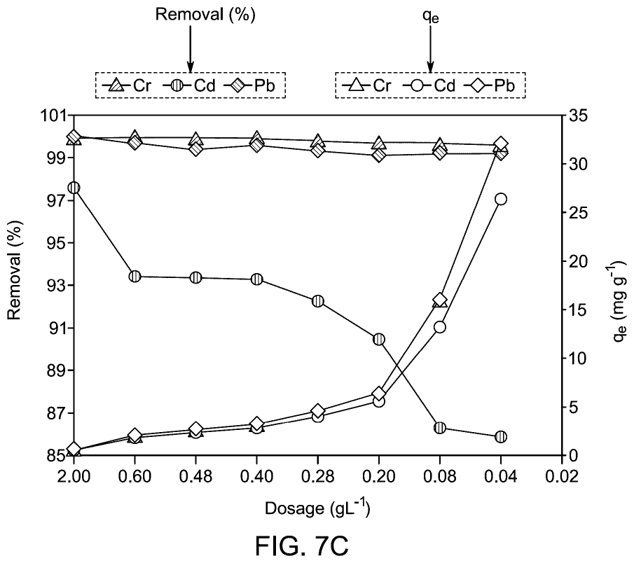

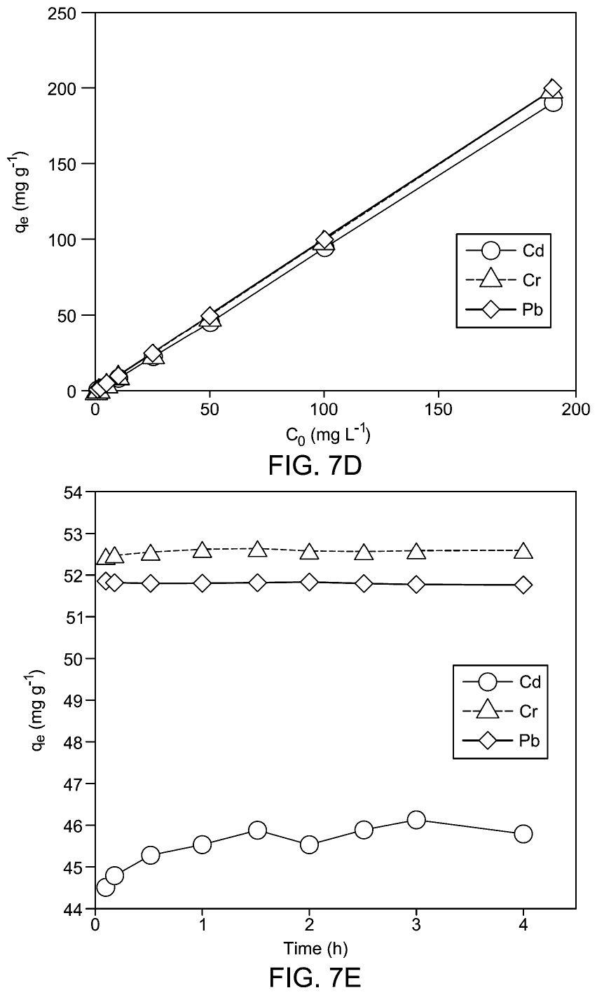

The effect of pH on the adsorption of heavy metal ions was studied by varying the pH from acidic to basic values (pH 2 to 8) (FIG. 7A; TABAMA dosage=2 g/L, the concentration of metal ions=50 mg/L, pH=2.0 to 8.0, and shaking time=3 h). At acidic pH values (up to pH 4), the studied metal ions Cd, Pb, and Cr did not show removal except for Pb ions, and Pb ions were removed up to 72%. As the pH was increased, the percent removal was increased, reaching >99% for the metal ions at more basic pH values.

The trend in the pH effect can be explained by considering the changes in the chemistry of TABAMA resin, as depicted in FIG. 7B. At strongly acidic pH values, the residual amines are progressively protonated, leading to the generation of quarternary ammonium ions in the TABAMA structure. The positive charge of the resin develops electrostatic repulsive interaction with the heavy metal ions. The electrostatic repulsion results in lower removal at acidic pH; however, the availability of certain groups, such as >C═O groups of —COOH and amide (—CONH) groups, can develop secondary interactions with heavy metal ions responsible for the removal of metal ions. As the pH of the medium increases, the deprotonation of the quarternary ammonium ions and —COOH groups results in the restoration of lone pairs on N atoms of residual amino groups and negative charge on —COO— groups. The lone pairs and negative charge of —COO— develop strong interactions with metal ions. The amino groups act as ligands for metal ions, resulting in metal-complexation, whereas the negative charge of —COO— groups develops strong electrostatic interactions with the metal ions, leading to a higher percentage removal of heavy metal ions.

Therefore, the adsorption mechanism of the metals onto the TABAMA resin depends on the protonation and deprotonation of the functional groups of the resin. Protonation happens readily at acidic pH because excess protons are available in acidic conditions, which can be taken up by functional groups in the resin and develop a positive charge on the resin. Hence, the resin becomes resistant to the positively charged metal ions. Excess protonation or strongly acidic conditions are not desirable for removal of metal ions by resins such as TABAMA. Less acidic, neutral, and slightly basic conditions lead to deprotonation of the TABAMA resin generating a negative charge for attracting positively charged heavy metal ions; however, strongly basic conditions must be avoided during metal removal studies as excessive bases in the medium can precipitate the metal ions.

Further experiments were conducted at pH 6 as strongly basic conditions led to the precipitation of metal ions. The dosage optimization is illustrated in FIG. 7C with conditions of a TABAMA dosage of 2 g/L, concentration of metal ions of 50 mg/L, pH of 2.0 to 8.0, and shaking time of 3 hours. Removal of the metal ions stayed at high values for different adsorbent dosages for both Pb and Cr. The percent removal of the metal ions increased with increasing adsorbent dosages. An increase in adsorbent dosage leads to an increase in the number of active sites available for the adsorption of metal ions. The percent removal of Cd depends upon the adsorbent dosage and reached the highest removal of 97.6% at a dosage of 2.0 g·L⁻¹. The adsorption capacity of the adsorbent for different metal ions was also found to be dependent upon the adsorbent dosage and reached 31.9 mg/g, 26.4 mg/g, and 32.1 mg/g for Cr, Cd, and Pb, respectively. The high adsorption capacity indicates that the TABAMA resin has a high affinity for heavy metal ions, which is attributed to the mesoporous nature of the resin. Furthermore, the resin also possesses several functional groups that have been identified by FTIR (FIG. 2A), including —NH, —COOH, —CONH, and benzene rings. These functional groups develop strong secondary and electrostatic interactions, leading to higher adsorption capacity for metal ions.

Further, the effect of varying metal ion concentrations (0 mg·L⁻ to 200 mg·L⁻¹) on the adsorption capacity was analyzed at an adsorbent dose of 0.025 g. The adsorption capacity increased with increasing concentrations of metal ions, which may be attributed to the increasingly occupying behaviors of the metal ions. At higher metal concentrations, the adsorbent active sites are covered and filled by the metal adsorbate. The adsorption capacities for Cr, Cd, and Pb were found to be 199.9 mg/g, 190.5 mg/g, and 199.8 mg/g, respectively (FIG. 7D; TABAMA dosage=1.0 g/L, concentration of metal ions=1 mg/L to 200 mg/L, pH=6.0, and shaking time=3 h) at a concentration of 200 mg·L⁻¹. The effect of time on the adsorption capacity was studied by varying the adsorption time from 0 hours to 4 hours. In the case of Cr and Pb metal ions, the adsorption reached equilibrium almost immediately at a given metal ion concentration. The equilibrium was reached slightly later, around 60 minutes (min), for Cd. The equilibrium adsorption capacities of Cr, Pb, and Cd were found to be 52.5 mg/g, 51.9 mg/g, and 45.8 mg/g after 0.08 h, equivalent to 5 minutes of adsorption experiments (FIG. 7E; TABAMA dosage=1.0 g/L, the concentration of metal ions=50 mg/L, pH=6.0, and shaking time from 0.08 h to 4 h). The faster adsorption rate and increased adsorption capacity of the adsorbent for heavy metal ions indicates application of TABAMA for removal of metal ions form wastewater streams.

The interaction of metals with the absorbent can be understood through absorption models, which are generally Langmuir and Freundlich models. The data generated during the adsorption of metal ions represented the fitting for Langmuir and Freundlich models. The Freundlich model is given by the Eq. 3.

$$log {q}_{e} = log {k}_{F} + \frac{1}{n} log {C}_{e} \qquad ( 3 )$$

In this equation, k_{F} and n represent absorption isotherm constants, which indicate the extent of adsorption and degree of non-linearity between solution concentration and absorption, respectively. The values of k_{F} and 1/n can be calculated from the intercept and slope of the linear plot between log Cₑ and log qₑ. Cₑ represents the equilibrium concentration of the adsorbate within the solvent and qₑ represents a ratio between the adsorbed mass of the adsorbate and the mass of the adsorbate.

The Langmuir model is represented by the Eq. 4.

$$\frac{1}{{q}_{e}} = \frac{1}{{q}_{max}} + \frac{1}{{k}_{L} {q}_{max}} \frac{1}{{C}_{e}} \qquad ( 4 )$$

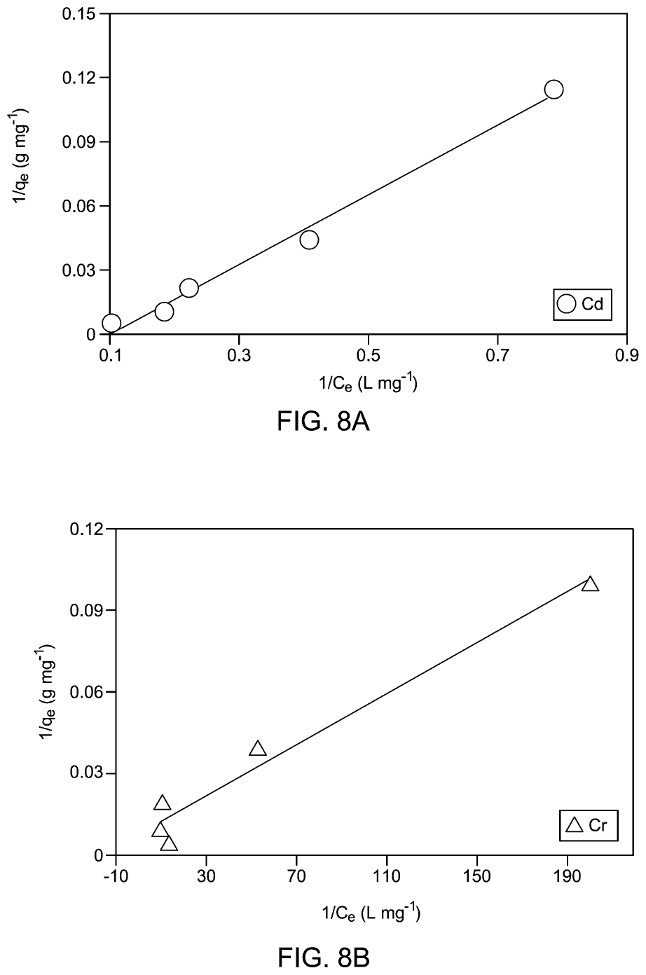

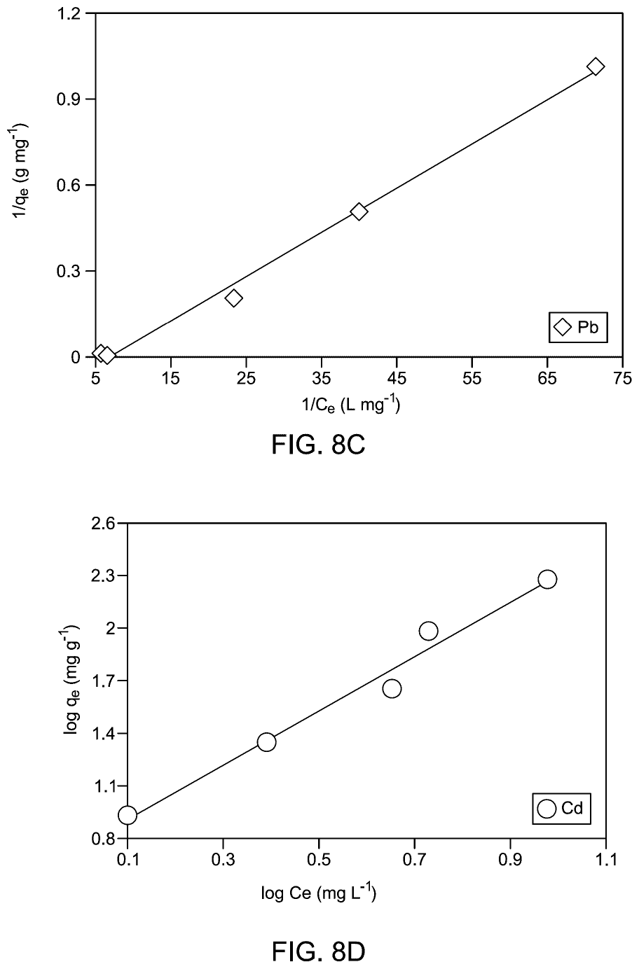

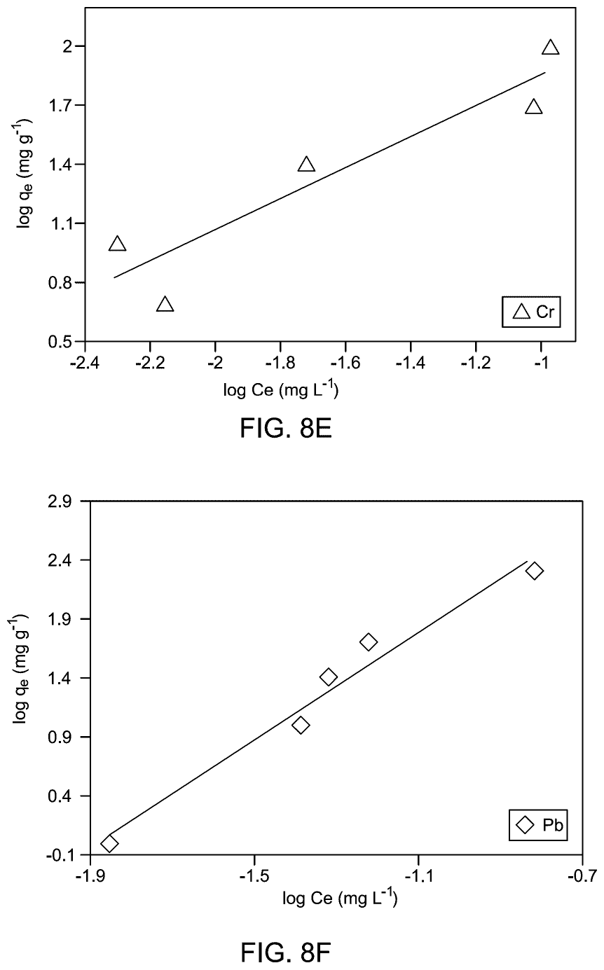

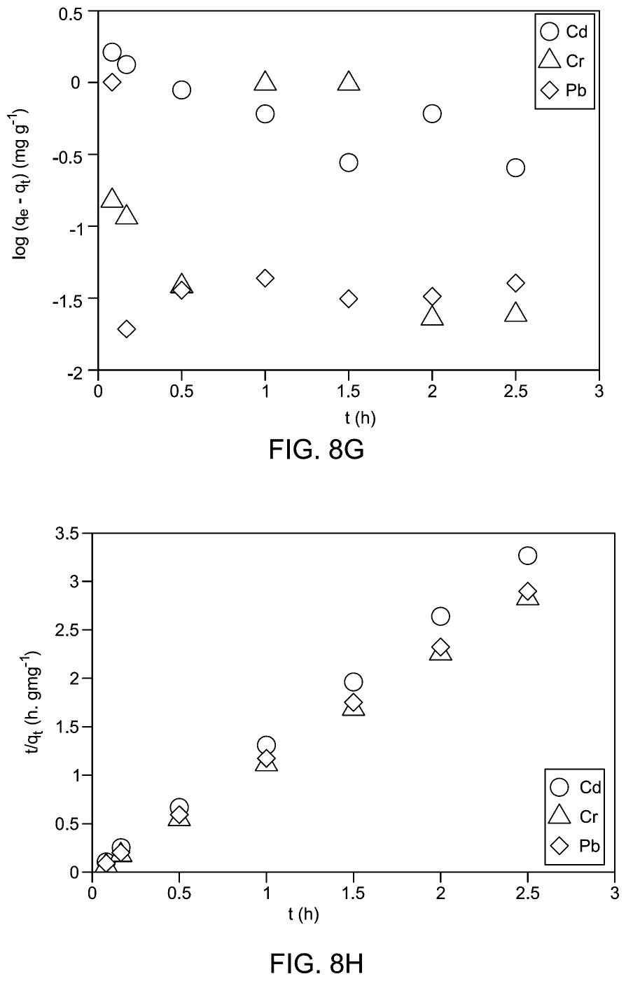

In this equation, qₘₐₓ stands for the maximum amount of absorption of an adsorbate per gram of an adsorbent, which is the maximum absorption capacity of an adsorbent given in milligrams per gram, and k_{L} is the Langmuir constant given in liters per milligram, which is related to the energy of adsorption. The values of Langmuir constant k_{L} and qₘₐₓ can be determined by a linear plot of 1/Cₑ versus 1/qₑ, where qₘₐₓ can be deduced from the intercept while k_{L} can be calculated from the slope of the equation. Cₑ represents the equilibrium concentration of the adsorbate within the solvent and qₑ represents a ratio between the adsorbed mass of the adsorbate and the mass of the adsorbate. The Freundlich model is applied for heterogeneous systems and reversible absorption. In the case of the Langmuir model, the absorption is not restricted to mono-layer formation. The structure of the adsorbent is assumed to be uniform throughout. It is a fully homogenous structure and has the same energy of adsorption on all the sides of the adsorbent used in a particular study. The plots for Langmuir and Freundlich models of Cd, Cr, and Pb are given in FIG. 8A-FIG. 8C and FIG. 8D-FIG. 8F, respectively. The investigation and study of the correlation coefficients (r²) revealed that both Langmuir and Freundlich models were fit for the data generated during the adsorption of all three metal ions indicated by the value of r² reaching unity. Among the Langmuir and Freundlich models, a comparison of the correlation coefficient revealed that the Langmuir model was more fit than the Freundlich model for the adsorption of all of the metals by the adsorbent. The maximum adsorption capacities for Cd, Cr, and Pb were 60.98 mg/g, 119 mg/g, and 9.302 mg/g, respectively. Similarly, the values of the correlation coefficient for Cd, Cr, and Pb were found to be 0.9911, 0.967, and 0.995, respectively, using the Langmuir model.

To determine the mechanism used during the adsorption of metal ions on the adsorbent, different kinetic models were applied. The pseudo-first-order kinetics model and the pseudo-second-order kinetics model were used to explain the adsorption of metal ions. The pseudo-first-order model is given by the following Eq. 5 [Waheed, A., Mansha, M., Kazi, I. W., Ullah, N., Synthesis of a novel 3,5-diacrylamidobenzoic acid based hyper-cross-linked resin for the efficient adsorption of Congo Red and Rhodamine B. J Hazard Mater 2019, 369, 528-538, which is incorporated herein by reference in its entirety].

$$log ( {q}_{e} - {q}_{t} ) = log {q}_{e} - \frac{{k}_{1} t}{2.303} \qquad ( 5 )$$

In this equation, qₜ represents the amount of metal absorbed on the adsorbent per given time t, whereas k₁ is the pseudo-first-order rate constant. The values of the k₁ rate constant can be determined by the plot of log (qₑ-qₜ) against time t.

The pseudo-second-order kinetic model is given by the following equation:

$$\frac{t}{{q}_{t}} = \frac{1}{{k}_{2} {q}_{e}^{2}} + \frac{t}{{q}_{e}} \qquad ( 6 )$$

where k₂ is the second order rate constant given in grams per milligram per minute. FIG. 7 shows the plots for both pseudo-first-order (FIG. 8G) and pseudo-second-order (FIG. 8H) kinetic models for the removal of metal ions. Comparison of the correlation coefficient for different metals due to first and second-order kinetic models revealed that the pseudo-second-order model was the best-fit model for the data obtained during the adsorption of metal ions by the adsorbent. Therefore, the mechanism of adsorption of metals depends on both the absorbate, which is the metals, and the adsorbent.

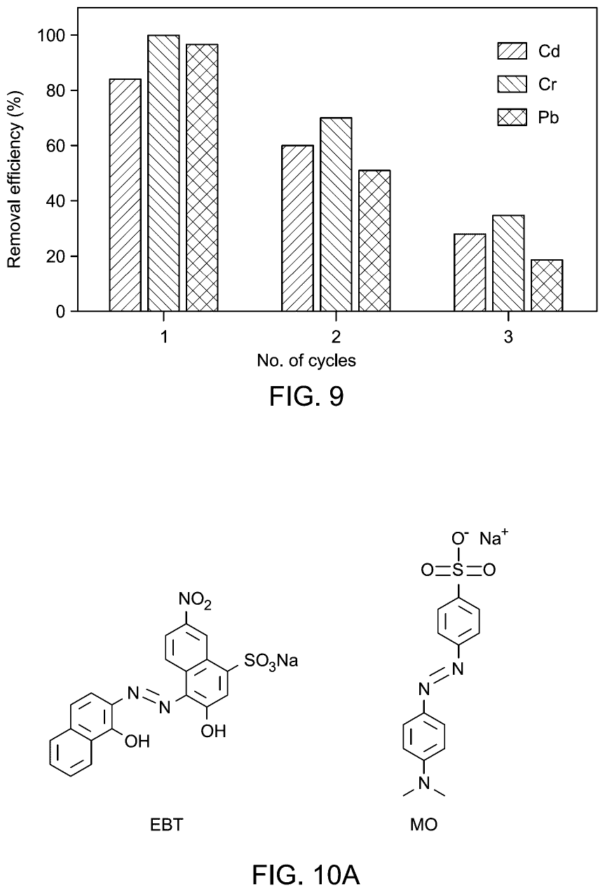

Regeneration experiments revealed that TABAMA resin was able to retain reusability after the first cycle of regeneration; however, the reusability of the resin decreased after the second cycle of regeneration. Although reusability of TABAMA resin was reduced after second cycle of regeneration, the resin still retained removal efficiency of >50%. After the third cycle, the reusability of the TABAMA resin was further reduced (FIG. 9).

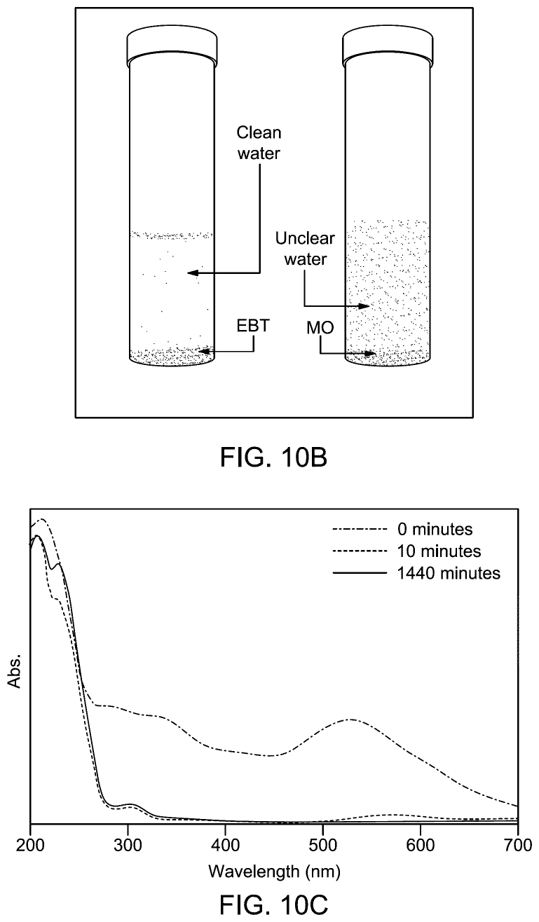

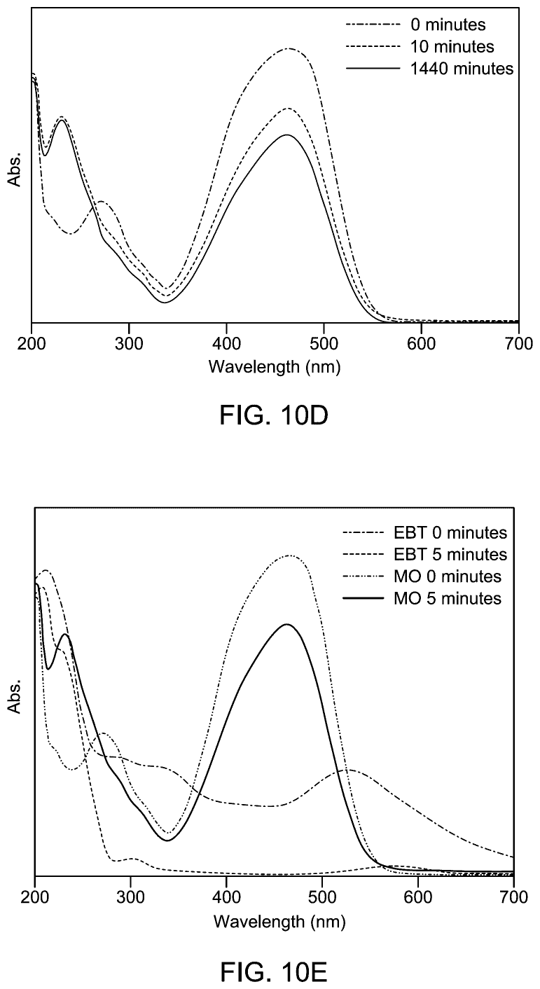

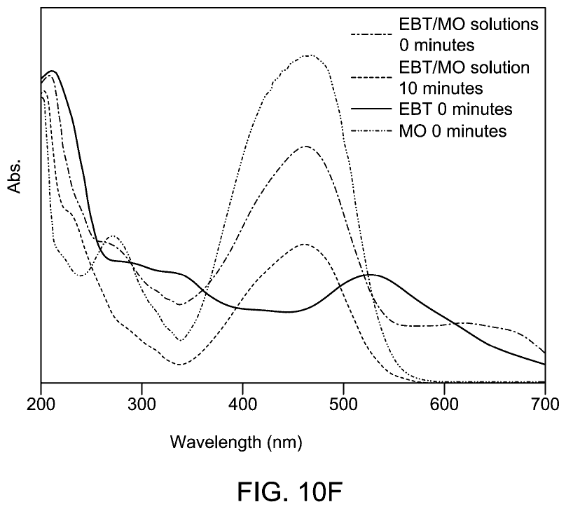

The TABAMA adsorbent can not only remove heavy metal ions, but it also can adsorb organic pollutants, such as dyes. The organic pollutants, eriochrome black t (EBT) and methyl orange (MO), are shown in FIG. 10A. When TABAMA was added to dyes containing aqueous solution at a pH of 7 and a concentration of 60 mg of dye per g of TABAMA and stirred for 5 minutes, the TABAMA adsorbed the dyes and settled to the bottom of the glass vials. In the case of EBT, after 5 minutes of adsorption, the supernatant water appeared clean of almost all the EBT (FIG. 10B). In case of EBT, almost complete removal occurs within 5 minutes, as seen in FIG. 10C; however, in the case of MO dye, the TABAMA resin was not able to fully remove the MO (FIG. 10D). The TABAMA resin showed a certain level of selectivity for removing EBT over MO, as shown in FIG. 10E. In the absorption spectra of the supernatant obtained after EBT removal, the absorption maximum of EBT (λₘₐₓ=550 nm) disappears after 5 minutes of adsorption; however, in the case of MO, the absorption maximum of MO (λₘₐₓ=450 nm) does not show a decrease in intensity after 5 minutes of adsorption. The TABAMA resin shows a selectivity of EBT over MO.

To further probe the selectivity of TABAMA for EBT, a mixture of EBT and MO dyes was prepared and adsorption was carried out by using TABAMA. FIG. 10F shows the absorption spectra of EBT, MO, and an EBT/MO mixture. FIG. 10F also shows the absorption spectrum of the supernatant of the EBT/MO mixture after 10 minutes of adsorption by TABAMA. A signal was not detected at λₘₐₓ=550 nm, the region attributed to EBT. A signal was selected at λₘₐₓ=450 nm, the region attributed to MO.

This selectivity of EBT over MO may be explained by the structures of the EBT and MO. Both EBT and MO are azo-dyes containing sodium sulfonate groups; however, the structure of EBT is different from MO in that hydroxy groups (—OH) are bonded to fused benzene rings in EBT. The presence of —OH groups in the structure of EBT leads to the development of hydrogen bonding interaction with functional groups of the TABAMA resin. Hydrophobic-hydrophobic interactions between the aromatic fused rings of EBT and benzene rings of 3,5-diaminobenzoic acid are also noted. Hydrogen bonding interactions are not observed in the case of MO as the MO is devoid of functional groups, such as —OH groups.

The TABAMA resin, synthesized through a single-step Micheal addition reaction, led to a resin decorated with multifunctional groups. Multiple amino groups in the structure of TEPA led to the TABAMA resin being a mesoporous material. The chemistry and structure of the TABAMA resin make it a good adsorption material for the treatment of wastewater streams. Furthermore, the use of multiple amino groups in one monomer and α,β-unsaturated functional groups in the other monomer opens up ways for developing efficient and cost-effective multifunctional monomers in the future for treating wastewater contaminated with heavy metals and organic pollutants. Furthermore, the selection of monomers and functional group tuning can lead to polymeric resins for extracting metal ions from water bodies. A comparison of performance of TABAMA resin with the other adsorbents has been given in the following Table 1. Compared to different adsorbents prepared through crosslinking or nanomaterial composites, TABAMA resin has shown a comparable or better performance for removing metals ions. In the case of dyes, TABAMA resin has shown selective and efficient removal of EBT over MB. The other adsorbents have shown non-selective removal of dyes. The proper selection of monomers and resulting chemistry of the polymeric adsorbent is important in targeting a specific application.

TABLE 1
A comparison of TABAMA resin with other adsorbents

| | | Dyes | | Adsorption | |
|---|---|---|---|---|---|
| Adsorbents | Dyes | removal | Metals | capacity (mg/g) | Ref. |
| Cd(II)-MIP | | | Cd²⁺ | 28.4 | [1] |
| Pb(II)-MIP | | | Pb²⁺ | 23.81 | [2] |
| TRIAZ-PA | EBT, MO | >59%, 88% | | | [3] |
| Chitosan/epichlorohydrin | | | Cd²⁺ | 38.46 | [4] |
| Allyl thiourea/EGDMA | | | Cd²⁺ | 38.30 | [5] |
| Allyl thiourea/EGDMA | | | Pb²⁺ | 47 | [6] |
| 2-methacryloylamido | | | Cr³⁺ | 69.2 | [7] |
| histidine/EGDMA | | | | | |
| Acrylamide/EGDMA | | | Cr³⁺ | 4.5 | [8] |
| CTAB@ZnO-NPs | EBT | 84% | | | [9] |
| BMTF@ZnO-NPs | EBT | 87% | | | [9] |
| EBPAR | EBT, MO | >97%, >99% | | | [10] |
| N-methacryloyl-(L)- | | | Pb²⁺ | 2.01 | [11] |
| cysteine/EGDMA | | | | | |
| SG-G2.0 | | | Cd²⁺ | 35.97 | [12] |
| G-3PAMAMSGA | | | Cd²⁺ | 28.49 | [13] |
| TABAMA resin | EBT, MO | >99%, 40% | Cd, Cr, | 60.98, 119 | This |
| | | | and Pb | and 9.30 | work |

[1] Xi, Y., Luo, Y., Luo, J., Luo, X., Removal of Cadmium(II) from Wastewater Using Novel Cadmium Ion-Imprinted Polymers. J. Chem. Eng. Data, 2015, 60, 3253-3261;
[2] Ao, X., Guan, H., Preparation of Pb(II) ion-imprinted polymers and their application in selective removal from wastewater. Adsorpt. Sci. Technol., 2018, 36, 774-787;
[3] Waheed, A., Kazi, I. W., Manzar, M. S., Ahmad, T., Mansha, M., Ullah, N., Ahmed Blaisi, N. I., Ultrahigh and efficient removal of Methyl orange, Eriochrom Black T and acid Blue 92 by triazine based cross-linked polyamine resin: Synthesis, isotherm and kinetic studies. Colloids Surfaces A Physicochem. Eng. Asp., 2020, 607, 125472;
[4] Rahangdale, D., Kumar, A., Archana, G., Dhodapkar, R. S., Ion cum molecularly dual imprinted polymer for simultaneous removal of cadmium and salicylic acid. J. Mol. Recognit., 2018, 31, e2630;
[5] Li, Min, Feng, C., Li, Mingyu, Zeng, Q., Gan, Q., Yang, H., Synthesis and characterization of a surface-grafted Cd(II) ion-imprinted polymer for selective separation of Cd(II) ion from aqueous solution. Appl. Surf. Sci., 2015, 332, 463-472;
[6] Mishra, S., Verma, N., Surface ion imprinting-mediated carbon nanofiber-grafted highly porous polymeric beads: Synthesis and application towards selective removal of aqueous Pb(II). Chem. Eng. J., 2017, 313, 1142-1151;
[7] Birlik, E., Ersöz, A., Açikkalp, E., Denizli, A., Say, R., 2007. Cr(III)-imprinted polymeric beads: Sorption and preconcentration studies. J. Hazard. Mater., 2007, 140, 110-116;
[8] Leśniewska, B., Jakubowska, I., Zambrzycka, E., Godlewska-Zyłkiewicz, B., 2016. A novel ion-imprinted polymeric sorbent for separation and determination of chromium(III) species in wastewater. Turkish J. Chem., 2016, 40, 933-943;
[9] Kaur, Y., Jasrotia, T., Kumar, R., Chaudhary, G. R., Chaudhary, S., Adsorptive removal of eriochrome black T (EBT) dye by using surface active low cost zinc oxide nanoparticles: A comparative overview. Chemosphere, 2021, 278, 130366;
[10] Manzar, M. S., Waheed, A., Qazi, I. W., Blaisi, N. I., Ullah, N., Synthesis of a novel epibromohydrin modified crosslinked polyamine resin for highly efficient removal of methyl orange and eriochrome black T. J. Taiwan Inst. Chem. Eng., 2019, 97, 424-432;
[11] Esen, C., Andac, M., Bereli, N., Say, R., Henden, E., Denizli, A., Highly selective ion-imprinted particles for solid-phase extraction of Pb²⁺ ions. Mater. Sci. Eng. C, 2009, 29, 2464-2470;
[12] Zhu, Y., Niu, Y., Li, H., Ren, B., Qu, R., Chen, H., Zhang, Y., Removal of Cd(II) and Fe(III) from DMSO by silica gel supported PAMAM dendrimers: Equilibrium, thermodynamics, kinetics and mechanism. Ecotoxicol. Environ. Saf., 2018, 162, 253-260; and
[13] Ebelegi, A. N., Ayawei, N., Inengite, A. K., Wankasi, D., Generation-3 Polyamidoamine Dendrimer-Silica Composite: Preparation and Cd(II) Removal Capacity. J. Chem. 2020, each of which are incorporated herein by reference in its entirety.

A hyper-cross-linked polymer-based adsorbent (TABAMA) was synthesized through a green, simple, and one-step Michael addition reaction and utilized for adsorptive removal of toxic metals and organic dyes from contaminated water. The synthesized adsorbent possesses a porous structure with various functional groups that play a role in the adsorption process. The synthesized adsorbent shows ultra-fast removal of Cr and Pb, and equilibrium was achieved within less than 5 minutes. The kinetics isotherms of the metals followed a pseudo-second-order model, and their adsorption isotherms were well-described by the Langmuir adsorption model. The maximum adsorption capacities for Cd, Cr, and Pb were 60.98 mg/g, 119 mg/g, and 9.302 mg/g, respectively. The adsorbent also exhibited fast and selective removal of EBT dye that was efficiently removed within 5 minutes, showing its capability to simultaneously remove inorganic and organic pollutants from contaminated water streams. Hyper-cross-linked polymer-based resins may be materials used for the remediation of environmental contaminants in aqueous media.

Numerous modifications and variations of the present disclosure are possible in light of the above teachings. It is therefore to be understood that within the scope of the appended claims, the invention may be practiced otherwise than as specifically described herein.

1: A polymeric adsorbent, including:
a polymer having:
reacted units of a tetraethylenepentamine (TEPA);
reacted units of a 3,5-diacrylamidobenzoic acid; and
reacted units of a methacrylamide,
wherein the TEPA, the 3,5-diacrylamidobenzoic acid, and the methacrylamide have a molar ratio of 2-4:1-3:0.5-2 in the polymer,
wherein the polymer is covalently crosslinked through at least a portion of the reacted units of the TEPA and the reacted units of the 3,5-diacrylamidobenzoic acid,
wherein the polymer is covalently crosslinked through at least a portion of the reacted units of the TEPA and the reacted units of the methacrylamide.

2: The polymeric adsorbent of claim 1, wherein one or more primary amines and one or more secondary amines of the reacted units of the TEPA are covalently bonded to the reacted units of the 3,5-diacrylamidobenzoic acid through one or more primary carbons of the reacted units of the 3,5-diacrylamidobenzoic acid.

3: The polymeric adsorbent of claim 1, wherein one or more primary amines and one or more secondary amines of the reacted units of the TEPA are covalently bonded to the reacted units of the methacrylamide through one or more primary carbons of the reacted units of the methacrylamide.

4: The polymeric adsorbent of claim 1, wherein the polymer is made by a process including:
dissolving the 3,5-diacrylamidobenzoic acid and the methacrylamide in a polar organic solvent to form a first solution;
mixing the TEPA with the first solution at a temperature of −10 to 10 degrees Celsius (° C.) for 30 to 90 minutes (min) to form a second mixture;
mixing the second mixture at a temperature of 40 to 60° C.; and
refluxing the second mixture to form the polymer.

5: The polymeric adsorbent of claim 1, wherein the adsorbent is in the form of agglomerates having a longest dimension of 5 to 50 μm made of particles having an average particle size of 25 to 250 nm and a surface area of 5 to 15 meter square per gram (m²/g).

6: The polymeric adsorbent of claim 1, wherein the adsorbent is in the form of particles that are porous and have a pore volume of 0.01 to 0.1 cubic centimeters per gram (cm³/g).

7: The polymeric adsorbent of claim 1, wherein the adsorbent is in the form of particles that are porous and have a pore size of 1 to 3 nanometers (nm).

8: The polymeric adsorbent of claim 1, wherein the adsorbent is in the form of particles that are agglomerated and have an average particle size of 50 to 300 nm.

9: A method of water treatment, including:
contacting the polymeric adsorbent of claim 1 with an aqueous solution including one or more pollutants;
adsorbing the one or more pollutants on the polymeric adsorbent; and
collecting a filtrate solution,
wherein the filtrated solution has fewer pollutants than the aqueous solution.

10: The method of claim 9, wherein the one or more pollutants are one or more metal ions and the one or more metal ions are adsorbed onto the polymeric adsorbent through metal ligand complexation with one or more amines of the reacted units of the TEPA and the reacted units of the methacrylamide.

11: The method of claim 9, wherein the one or more pollutants are one or more metal ions and the one or more metal ions are adsorbed onto the polymeric adsorbent through electrostatic interactions with one or more oxygen-containing functional groups of the reacted units of the 3,5-diacrylamidobenzoic acid and the reacted units of the methacrylamide.

12: The method of claim 9, further including:
washing and drying the polymeric adsorbent after the contacting to regenerate the polymeric adsorbent;
contacting the regenerated polymeric adsorbent with an aqueous solution including one or more pollutants; and
adsorbing the one or more pollutants on the regenerated polymeric adsorbent.

13: The method of claim 12, wherein the regenerated polymeric adsorbent has a removal efficiency of the one or more pollutants of at least 50 percent (%) based on an initial amount of the one or more pollutants in the aqueous solution.

14: The method of claim 12, wherein adsorption of the one or more pollutants occurs in less than 10 minutes.

15: The polymeric adsorbent of claim 1, wherein the adsorbent has an adsorption capacity of 58 to 64 milligrams per gram (mg/g) for cadmium ions.

16: The polymeric adsorbent of claim 1, wherein the adsorbent has an adsorption capacity of 116 to 122 mg/g for chromium ions.

17: The polymeric adsorbent of claim 1, wherein the adsorbent has an adsorption capacity of 5 to 15 mg/g for lead ions.

18: The polymeric adsorbent of claim 1, wherein the adsorbent has a dye removal efficiency for eriochrome black t (EBT) of at least 99% based on an initial amount of the eriochrome black t.

19: The polymeric adsorbent of claim 1, wherein the adsorbent has a dye removal efficiency for methyl orange (MO) of 35 to 45% based on an initial amount of the MO.

20: The polymeric adsorbent of claim 1, wherein carboxylic acid functional groups in the reacted units of the 3,5-diacrylamidobenzoic acid do not react with reacted units of the TEPA and reacted units of the TEPA.
